(19) United States
(12) Patent Application Publication
(10) Pub. No.: US 2005/0052805 A1
(43) Pub. Date: Mar. 10, 2005

(54) Information processing apparatus and method, and computer-readable medium

(76) Inventors: Hideki Sato, Kanagawa (JP); Tetsuo Yoshikawa, Shizuoka (JP); Shigemitsu Kiso, Shizuoka (JP); Hajimu Iwai, Shizuoka (JP); Takehiko Seki, Kanagawa (JP)

Correspondence Address: DICKSTEIN SHAPIRO MORIN & OSHINSKY LLP, 2101 L Street, NW, Washington, DC, 20037, US

(21) Appl. No.: 10/900,310

(22) Filed: Jul. 28, 2004

(30) Foreign Application Priority Data
Aug. 21, 2003 (JP) 2003-297727

(51) Int. Cl. H02H 3/24

(52) U.S. Cl. 361/90

(57) ABSTRACT

A UPS monitoring part monitors a state of a UPS, on the basis of an information which was transmitted from the UPS which was connected to an information processing apparatus, and received by a UPS communication part. A UPS control part, on the basis of a result of that monitoring, generates a control information for individually controlling respective states of a plurality of electric power output parts of the UPS, in accordance with a condition of power-off of each load which was connected to the corresponding electric power output part, and carries out a control for transmitting it from the UPS communication part to the UPS.

### BACKGROUND OF THE INVENTION

1. Field of the Invention

The present invention relates to information processing apparatus and method, and a computer-readable medium storing instructions for operating the information processing apparatus. In particular, the present invention relates to an information processing apparatus and method, and a computer-readable medium which can individually control respective states of a plurality of electric power output parts of a power supply device, by use of one unit of an information processing apparatus.

2. Description of the Related Art

In recent years, information processing apparatuses have become popular, and its importance has been increased year by year. However, there are many cases that electric power which is consumed by an information processing apparatus is directly supplied from a commercial alternating current power source, and, because of this, there are many cases that, when there occurs something wrong with the commercial alternating current power source (for example, when there occurs instantaneous lowering (instantaneous shutoff) of a voltage, sudden blackout, etc.), there occur such defects that information which is processed by an information processing apparatus at that time point is damaged and lost, and in addition, an information processing apparatus itself (e.g., built-in hard disk etc.) gets out of order.

In this connection, in order to avoid occurrence of the suchlike defects, in recent years, there are many cases that a uninterruptible power supply unit (UPS) is connected to an information processing apparatus. This UPS, in case that a commercial alternating current power source is normal, supplies electric power from that commercial alternating current power source to an information processing apparatus, and, in case that a commercial alternating current power source is abnormal, switches its output, and can supply electric power from a built-in battery to an information processing apparatus.

By this, an information processing apparatus to which UPS was connected can use electric power which is supplied from a battery in UPS, even if there occurs something wrong with a commercial alternating current power source, and therefore, it becomes possible to continue processing as it is.

In this regard, however, a battery is a standby power supply to the bitter end, and its electric power supply capability has limitation. That is, such time that a battery is capable of outputting a voltage of a predetermined level or more (hereinafter, the suchlike time is referred to as power feedable time) has limitation. On this account, within this power feedable time, there is such a necessity that an information processing apparatus stops processing which has been carried out up to now, and carries out processing for transferring a state of itself from an operating state to such a state that it is enabled even if a power source is shut off (hereinafter, the suchlike group of processing is referred to as shutdown processing).

Concretely speaking, for example, there are many cases that a computer etc. out of an information processing apparatus is executing application software which is operated on a predetermined OS (Operating System). In this case, the computer etc. launches its application, as the shutdown processing, and also, stores necessary data arbitrarily, and then, carries out processing for launching its OS.

On one hand, when discharge of a battery is carried out more than necessary, there occurs such defects that life of the battery is shortened, and it becomes unavailable for use (impossible to discharge again at a voltage with a level which satisfies a specification) even if it is charged again. On this account, there is such a necessity that, after an information processing apparatus completed the shutdown processing, as soon as possible, UPS which was connected to the information processing apparatus carries out processing for stopping discharge of a built-in battery, i.e., processing for transferring a state of the UPS from an operating state for outputting electric power to a stop state for prohibiting its output (hereinafter, the suchlike processing is referred to as UPS stop processing).

In this connection, OMRON Corporation is conducting sales of application software as shown in “Uninterruptible Power Supply Unit (UPS) Technical Manual Shutdown Software/Battery/FAQ/Successor Machine Version” written by OMRON Corporation, published by OMRON Corporation, published on Apr. 1, 2003, p. 4-9 (hereinafter, the suchlike application software is referred to as shutdown software). An information processing apparatus in which this shutdown software was installed monitors a state of UPS which was connected to it, and carries out the shutdown processing, in case that there occurred something wrong with an input power source of UPS, and can have the UPS carried out the UPS stop processing.

In addition, here, in case of having focused on a predetermined apparatus, an object for supplying (inputting) electric power (regardless of whether that apparatus consumes or not) to that apparatus is referred to as an input power source. For example, as a matter stands now, UPS is focused on, and an object for supplying (inputting) electric power to that UPS is a commercial alternating current power source, and therefore, this commercial alternating current power source becomes an input power source.

In other words, UPS having an electric power output port and a communication port for carrying out communication with a computer which was connected to it can transmit information showing a state of UPS (information showing abnormality of an input power source, and soon) to a computer in which the shutdown software was installed, through the communication port, and can obtain control information which was transmitted from the computer (an instruction for having UPS stop processing carried out) through the communication port, and can carry out the UPS stop processing in accordance with the instruction.

Furthermore, in recent years, UPS having plural sets of electric power output ports and communication ports (hereinafter, the suchlike UPS is referred to as multiple output UPS, in case that there is a necessity to set it apart from UPS having only one set of the electric power output port and the communication port) has been appeared (e.g., see, JP-A-2001-242968).

The suchlike multiple output UPS can connect, for example, each of two or more constituent elements of an information processing system (one or more computers which are connected to one another through a network, and to which the shutdown software was connected, and other devices whose number is arbitrary (including 0 unit)).

In this regard, however, in case that the multiple output UPS is utilized as a common power source of constituent elements of an information processing system in this manner, it is requested that control of its electric power output is unified control which made consideration of an entire information processing system. However, in the related art, there has been such a problem that it is possible to carry out only such distributed control that each of respective constituent elements of an information processing system (in this regard, however, only an information processing apparatus in which shutdown software was installed) controls independently only predetermined one out of a plurality of electric power ports, and it is difficult to respond to the suchlike request.

Concretely speaking, for example, in the related art, in order to control a predetermined one output state, among a plurality of electric power ports of a multiple output UPS, utilized is control information which is transmitted from a computer connected to that electric power port, and received by a communication port associated with that electric power port. In other words, each of a plurality of computers connected to one multiple output UPS can control an output state of an electric power port to which itself was connected, but can not control an output state of another electric power output port.

In this connection, for example, there is such a necessity that a user carries out setup for controlling each of the plurality of electric power ports (setup necessary for generating information) with respect to each corresponding computer (computer which was connected to an electric power port as a setup object) respectively. That is, such a complicated operation becomes necessary that a user individually inputs information which is necessary for setup for controlling each of respective electric power ports (hereinafter, the suchlike information is referred to as setup information) with respect to each corresponding computer, and a problem such as an inputting error tends to take place by just that much.

Furthermore, for example, in case that the number of constituent elements of an information processing system is increased (e.g., a new computer is added), and a content in an existing constituent element of the information processing system is changed (e.g., new application software is added to a predetermined computer), such a complicated work becomes necessary that a user reads out and makes sure each past setup information of each electric power port from each of corresponding computers, and then, redesigns each setup information of each electric power port. Also, a user has to carry out again such a complicated operation that each setup information of each electric power port which was redesigned in this manner is made to be inputted (distributed and then, inputted) individually to each of a plurality of computers.

Also, there are many cases that a device which can not communicate with a multiple output UPS (device which can not be connected to a communication port) such as a router, a switching hub, or an external hard disk is included in the suchlike system, and in the related art, an output state of an electric power output port to which these devices were connected becomes substantially a uncontrolled state.

### SUMMARY OF THE INVENTION

An object of the present invention is to provide an information processing apparatus and method, and a computer-readable medium which enables individual control of respective state of a plurality of electric power output parts of a power supply device, by use of one unit of an information processing apparatus.

For achieving the foregoing object, there is provided with an information processing apparatus of the invention comprising:
a first communication unit for bilaterally transmitting and receiving an information to and from a power supply device having a plurality of output parts for outputting an electric power;
a monitoring unit for monitoring a state of the power supply device, on the basis of the information which was transmitted from the power supply device and received by the first communication unit; and
a control unit for carrying out a control for generating a control information for individually controlling respective states of the plurality of the output parts of the power supply device, on the basis of a result of monitoring of the monitoring unit, and for transmitting the control information from the first communication unit to the power supply device.

In the information processing apparatus of this invention, a state of the power supply device is monitored on the basis of the information which was transmitted from the power supply device having the plurality of output parts for outputting the electric power, and, on the basis of a result of the monitoring, generated is the control information for controlling respective states of the plurality of output parts of the power supply device, and the control information is transmitted to the power supply device.

By this, by use of one unit of the information processing apparatus of this invention, it becomes possible to individually control respective states of a plurality of electric power output parts of the power supply device.

The power supply device can be configured as a uninterruptible power supply unit (its output part corresponds to an electric power output port in the above-described multiple output UPS) etc.

The first communication unit can be configured as, for example, a communication port and a communication card etc. having a function for bilaterally carrying out serial communication with the power supply device.

The monitoring unit can be configured as, for example, a CPU (Central Processing Unit) which executes application software having a function for monitoring a state of a power supply device, on the basis of the information which was transmitted from the power supply device and received by the first communication unit.

The control unit can be configured as, for example, a CPU for executing application software which has a function for generating the control information for individually controlling respective states of a plurality of output parts of the power supply device, on the basis of a result of monitoring of the monitoring unit, and for having the first communication unit transmitted to the power supply device.

Furthermore, the control unit of the information processing apparatus of this invention can, in case that it was monitored by the monitoring unit that there occurred something wrong with an input power source of the power supply device, may carry out a control for determining individually respective stop timings for taking down respective outputs of the plurality of the output part of the power supply device, in accordance with characteristics of respective loads of the corresponding output parts, for generating the control information including at least each of the stop timings of the plurality of the output parts, and for transmitting the control information from the first communication unit to the power supply device.

By this, in case that there occurred something wrong with the input power source of the power supply device, it becomes possible for each of the plurality of output parts to stop an output of electric power, at appropriate timing which corresponded to a character of a connected load.

Also, the information processing apparatus of this invention may further comprise:
a setup unit for setting up, as respective features of the one or more load, which are connected to the plurality of output parts of the power supply device, respective preparation times which are necessary for a preparation to shutoff of an electric power from the corresponding output part, which is carried out by each of those loads,
wherein the control unit, in case of individually determining the stop timing of each of the plurality of the output parts of the power supply device, searches the preparation time of maximum length, out of the preparation time of each of one or more the load of the output part to draw attention, among the preparation times which were set up by the setup unit, and determines the stop timing of the output part to draw attention on the basis of the searched preparation time of maximum length.

The setup unit can be configured as a CPU which executes application software having a function for setting up each of preparation times necessary for the preparation to shutoff of the electric power from the corresponding output part, which is carried out by each of one or more loads as, for example, respective features of one or more loads of each of the plurality of output parts of the power supply device.

By this, by use of one unit of an information processing apparatus of this invention, it becomes possible to carry out setups in a lump, which are necessary for individually controlling states of the plurality of output parts of the power supply device. That is, for a user, it becomes possible to carry out setup of setup information simply and surely (without any erroneous setup), as compared with a related-art setup method (such a setup method that a user individually and manually inputs corresponding one setup information, to each of a plurality of computers).

Also, even in case that a plurality of loads are connected to output part of the power supply device, when there occurred something wrong with the input power source of the power supply device, it becomes possible for its output part to stop an output of electric power at appropriate timing such as a time point that all of a plurality of connected loads completed preparation to power supply shutoff.

Also, in case that the power supply device has a plurality of electric power outlets (electric power output ports), the information processing apparatus of this invention can control, on the supposition that each of those plurality of electric power outlets is regarded as one output part, their states individually. Furthermore, the information processing apparatus of this invention can also carry out control of an output state of electric power, on the supposition that a plurality of sets comprising the predetermined number of electric power outlets are formed (there is not necessity that the number of electric power outlets in each set is identical) and each of those plurality of sets is regarded as one output part (output part to which a plurality of loads are connected, since one electric power outlet is connected to one load), with a unit of these sets.

Furthermore, the control unit of the information processing apparatus of this invention can carry out a control for determining a stop timing of the power supply device itself for transferring a state of the power supply device from an operating state for having electric power outputted from at least one out of the plurality of the output parts to a stop state for having all output of the plurality of the output part stopped, on the basis of the preparation time of maximum length out of all of the preparation times which were set up by the setup unit, for generating the control information further including the stop timing of the power supply device itself, in addition to the stop timing of each of the plurality of the output parts of the power supply device, and for transmitting the control information from the first communication unit to the power supply device.

By this, for example, in case that the power supply device is a UPS, it becomes possible for the UPS to carry out the above-described UPS stop processing, when there occurs something wrong with an input power source, at appropriate timing such as a time point that all of loads connected to it completed preparation to power-off. That is, in UPS in which there occurs something wrong with an input power source, it is possible to suppress unnecessary discharge of a built-in battery, and as a result, it becomes possible to avoid deterioration (cut-down of life) etc. of the battery.

Also, the information processing apparatus itself of this invention itself may be connected to predetermined one out of the plurality of the output parts, as the load of the power supply device, and the information processing apparatus further may comprise:
a state transfer unit for stopping a processing which has been carried out by the information processing apparatus itself up to now, in case that it was monitored by the monitoring unit that there occurred something wrong with an input power source of the power supply device, and for transferring a state of the information processing apparatus itself from an operating state to such a state that it is enabled even if an electric power from the output part of the power supply device, to which the information processing apparatus itself was connected was shut off, in accordance with a predetermined procedure,
wherein the setup unit sets up such time that a first delay time from a time point when the state transfer unit judged to carry out the state transfer processing until when it is actually started is added to such processing time that the state transfer unit carries out the state transfer processing, as the preparation time of the information processing apparatus itself.

The state transfer unit can be configured as a CPU for executing application software having an executive function of state transfer processing (i.e., the above-described shutdown processing).

By this, even in case that there occurs something wrong with an input power source of the power supply device, an information processing apparatus of this invention can surely complete shutdown processing, before power supply from the power supply device is shut off, and therefore, it becomes possible to protect information which has been processed by an information processing apparatus itself of this invention, and the information processing apparatus itself of this invention.

Further, the information processing apparatus of this invention may comprises:
a second communication unit for bilaterally transmitting and receiving an information to and from another information processing apparatus which was connected to predetermined one out of the plurality of the output parts of the power supply device,
wherein the setup unit sets up such time that a second delay time from a time point when the another information processing apparatus judged to carry out a state transfer processing until when it is actually started is added to such processing time that the another information processing apparatus carries out the state transfer processing, as the preparation time of the another information processing apparatus, and
wherein the state transfer unit, at such a time point that it judged to carry out the state transfer processing of the information processing apparatus itself, further carries out a control for generating an instruction for having the another information processing apparatus started the state transfer processing after the second delay time, which was set up by the setup unit, has passed, and for transmitting the instruction from the second communication unit transmitted to the another information processing apparatus.

The second communication unit can be configured as, for example, a modem, a terminal adapter etc. which can be connected to a predetermined network or another information processing apparatus itself.

By this, it becomes possible for an information processing apparatus of this invention to control timing of shutdown of another information processing apparatus. That is, even in case that there occurred something wrong with an input power source of the power supply device, an information processing apparatus of this invention can surely complete shutdown processing of another information processing apparatus, as well as an information processing apparatus itself of this invention, before power supply from the power supply device is shut off, and therefore, it becomes possible to protect information which has-been processed by another information processing apparatus, and another information processing apparatus itself.

Also, in case that an information processing apparatus of this invention functions as a master which manages another information processing apparatus as a slave, there are many requests to delay shutdown timing of the master (information processing apparatus of this invention) than the slave (another information processing apparatus), and for example, by adjusting first delay time and second delay time, it becomes possible to meet the suchlike requests.

An information processing method of this invention is an information processing method of an information processing apparatus having a communication unit for bilaterally transmitting and receiving an information to and from a power supply device which has a plurality of output parts for outputting an electric power, the method comprising:
monitoring a state of the power supply device, on the basis of the information which was transmitted from the power supply device and received by the communication unit;
carrying out a control for generating a control information for individually controlling respective states of the plurality of the output parts of the power supply device, on the basis of a result of monitoring of the monitoring step; and
transmitting the control information from the communication unit to the power supply device.

A computer-readable medium of this invention is an a computer-readable medium storing instructions for operating an information processing apparatus which has a communication unit for bilaterally transmitting and receiving an information to and from a power supply device which has a plurality of output parts for outputting an electric power, the instructions comprising:
monitoring a state of the power supply device, on the basis of the information which was transmitted from the power supply device and received by the communication unit;
carrying out a control for generating a control information for individually controlling respective states of the plurality of the output parts of the power supply device, on the basis of a result of monitoring of the monitoring step; and
transmitting the control information from the communication unit to the power supply device.

In the information processing method and the computer-readable medium of this invention, targeted is an information processing apparatus which has a communication unit for bilaterally transmitting and receiving an information to and from a power supply device which has a plurality of output parts for outputting an electric power. That is, when the information processing apparatus carries out the information processing method of this invention and the information processing apparatus is controlled by the instructions of the computer-readable medium of this invention, transmission is carried out from the power supply device, and on the basis of information which was received by the communication unit, a state of the power supply device is monitored, and on the basis of its monitoring result, generated is control information for individually controlling respective states of the plurality of output parts of the power supply device, and the generated control information is transmitted from the communication unit to the power supply device.

By this, in the same manner as an information processing apparatus of this invention, in case that a power supply device having a plurality of output parts (e.g., above-described multiple output UPS) is connected as an input power source of an information processing apparatus which is targeted by an information method, or a computer-readable medium of this invention, by use of one unit of the information processing apparatus, it becomes possible to individually control output states of the plurality of output parts of the power supply device.

An information processing apparatus which is targeted by an information processing method, or a computer-readable medium of this invention can be configured by, for example, a computer etc. which functions as a server, and in particular, communication unit can be configured as, for example, a communication board, a communication card etc., which has a function for carrying out serial communication with a each of a plurality of power supply device each other, respectively.

Also, this power supply device which carries out communication with a communication unit can be configured as, for example, the above-described multiple output UPS.

The monitoring step can be configured as a monitoring step in which a state of a power supply device is monitored by a CPU, on the basis of information which was transmitted from the power supply device and received by the communication unit.

The control step can be configured as, for example, a control step in which, on the basis of a result of monitoring processing of the monitoring step, control information for controlling respective states of a plurality of output parts of the power supply device is generated by a CPU, and by the CPU, carried out is control for having the control information transmitted from the communication unit to the power supply device.

As above, according to this invention, one unit of a power supply device (e.g., UPS) can be utilized as respective power sources of a plurality of devices. In particular, it is possible to individually control respective state of a plurality of electric power output parts of the power supply device, by use of one unit of an information processing apparatus. That is, as for each of the plurality of devices, eliminated is the need for individually controlling an output state of an electric power output part to which itself was connected.

### BRIEF DESCRIPTION OF THE DRAWINGS

FIG. 1 is a block diagram which shows a configuration example of an information processing system to which this embodiment is applied;

FIG. 2 is a view which shows a configuration example of an outer appearance of a rack which is capable of accommodating all of constituent elements (an information processing apparatus, a device, and a UPS) of the information processing system of FIG. 1;

FIG. 3 is a block diagram which shows a configuration example of an information processing apparatus in the information processing system of FIG. 1, i.e., a configuration example of an information processing apparatus to which this embodiment is applied;

FIG. 4 is a functional block diagram which explains functions to which this embodiment is applied, among functions that the information processing apparatus of FIG. 3 has;

FIG. 5 is a view which shows an example of an image for inputting control information for controlling an output state of each output part of UPS;

FIG. 6 is a view which shows an example of an image for inputting control information for controlling an output state of each output part of UPS;

FIG. 7 is a view which shows an example of an image for inputting control information for controlling an output state of each output part of UPS;

FIG. 8 is a view which shows an example of an image showing a content of setup information which was inputted by utilizing the images of FIG. 5 through FIG. 7;

FIG. 9 is a block diagram which shows a configuration example of an inside of UPS (uninterruptible power supply unit) in the information processing system of FIG. 1;

FIG. 10 is a view which shows a configuration example of an outer appearance of the UPS (uninterruptible power supply unit) in the information processing system of FIG. 1;

FIG. 11 is a flow chart which explains processing for shutdown and UPS control, of an information processing apparatus in the information processing system of FIG. 1; and

FIG. 12 is a flow chart which explains processing for shutdown and UPS control, of an information processing apparatus in the information processing system of FIG. 1.

### DETAILED DESCRIPTION OF THE INVENTION

Hereinafter, with reference to the drawings, an information processing system, and an information processing apparatus, to which this embodiment is applied, will be described.

In addition, here, among apparatuses which are generally referred to as an information processing apparatus, an apparatus which requires execution of the above-described shutdown processing is referred, in particular, to as an information processing apparatus. That is, here, even in case of an apparatus which is generally referred to as an information processing apparatus, an apparatus which does not require the shutdown processing is referred, in particular, to as a device, in order to set it apart from the apparatus which is told here (apparatus which requires shutdown).

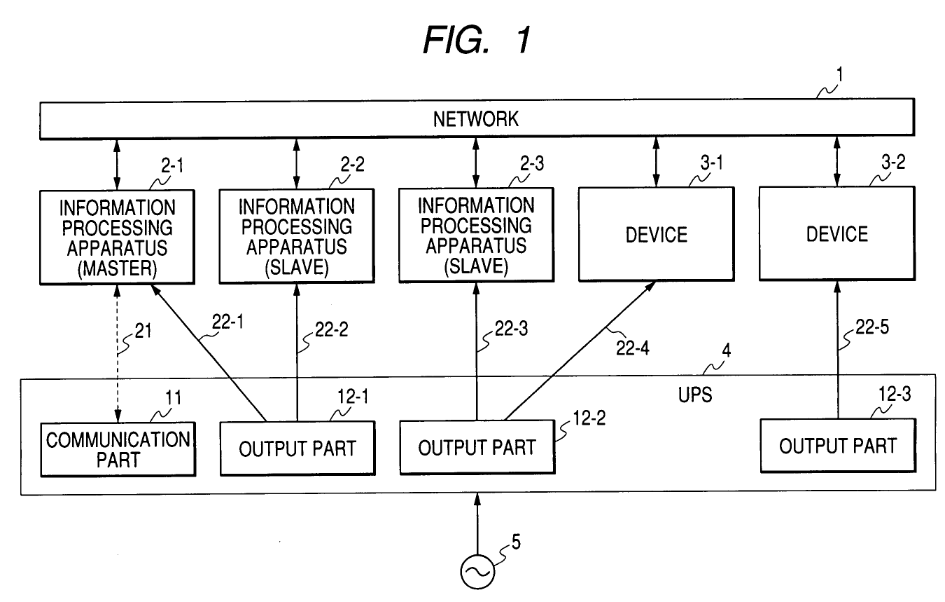

Also, in case that a predetermined power supply device (e.g., UPS 4 of FIG. 1 which will be described later) is utilized as a common power source of two or more information processing apparatuses (information processing apparatus which is told here), an information processing apparatus which carries out communication with the power supply device (e.g., an information processing apparatus 2-1 of FIG. 1 which will be described later) is referred to as a master arbitrarily, and an information processing apparatus other than that (e.g., an information processing apparatus 2-2 and an information processing apparatus 203 of FIG. 1 which will be described later) is referred to as a slave arbitrarily.

FIG. 1 represents a configuration example of an information processing system to which this embodiment is applied.

As shown in FIG. 1, the information processing system to which this embodiment is applied is composed of an arbitrary number of information processing apparatuses (in the example of FIG. 1, three units of an information processing apparatus 2-1 through an information processing apparatus 2-3), and an arbitrary number of devices (in the example of FIG. 1, two units of a device 3-1 and a device 3-2), and one unit of a UPS (a uninterruptible power supply unit) 4.

In this manner, in an information processing system to which this embodiment is applied, as an input power source (common power source) of each of the information processing apparatus 2-1 through the information processing apparatus 2-3, and the device 3-1 and the device 3-2, one unit of the UPS 4 is utilized.

That is, this UPS 4 has two or more output parts for outputting electric power (in the example of FIG. 1, three pieces of an output part 12-1 through an output part 12-3), and in case that a commercial alternating current power source 5, which is the input power source, is normal, electric power from this commercial alternating current power source 5 can be outputted from each of the output part 12-1 through the output part 12-3.

In addition, each of the output part 12-1 through the output part 12-3 may be configured as a so-called electric source outlet (electric power output port) itself, but maybe configured from a set comprising a plurality of power source outlets. In this regard, however, there is such a necessity that all of output state of a plurality of power source outlets are synchronized, in predetermined one set.

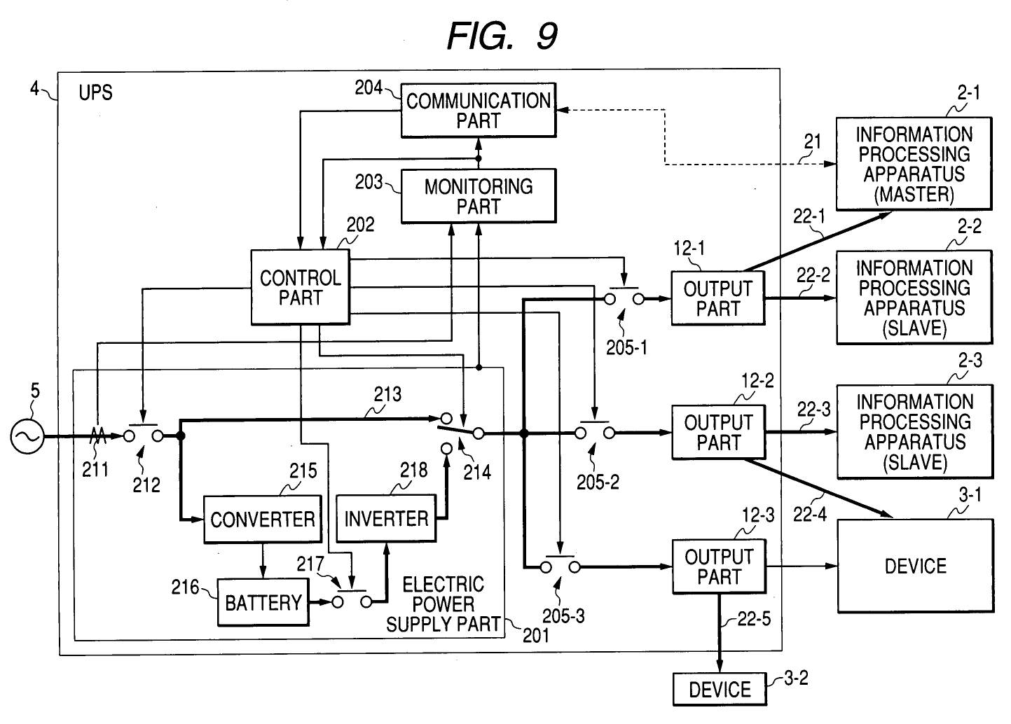

concretely speaking, for example, in this embodiment, as shown in FIG. 9 which will be described later, the information processing apparatus 2-1 can control respective output states of the output part 12-1 through the output part 12-3, by individually switching (transmitting its instruction to the UPS 4) each of states (On state or OFF state) of a switch 205-1 through a switch 205-3 in the UPS 4.

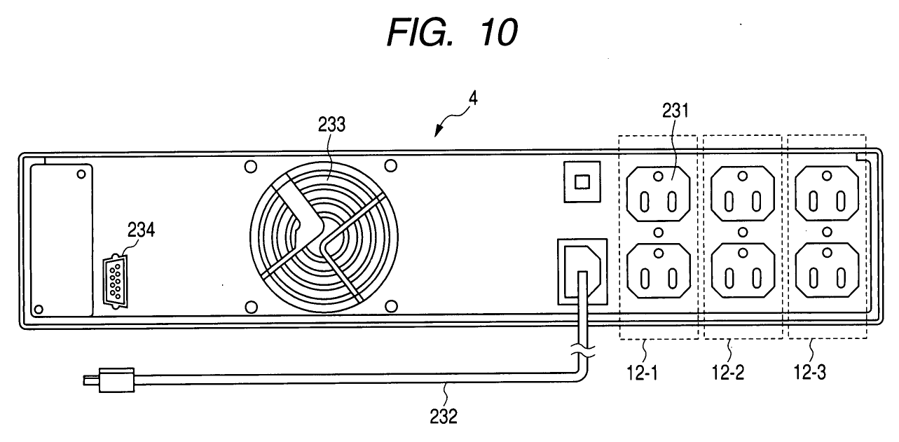

That is, the information processing apparatus 2-1 can control output states of a plurality of power source outlets (as shown in FIG. 10 which will be described later, two power source outlets 231) which were connected to the switch 205-1, by switching a state of the switch 205-1 synchronously. In the same manner, the information processing apparatus 2-2 can control output states of a plurality of power source outlets (as shown in FIG. 10 which will be described later, two power source outlets 231) which were connected to the switch 205-2, by switching a state of the switch 205-2 synchronously. Also, the information processing apparatus 2-3 can control output states of a plurality of power source outlets (as shown in FIG. 10 which will be described later, two power source outlets 231) which were connected to the switch 205-3, by switching a state of the switch 205-3 synchronously.

In this connection, in this embodiment, a set of power source outlets which were connected to each of these switch 205-1 through the switch 205-3 (as shown in FIG. 10 which will be described later, a set comprising two power source outlets 231) correspond to each of the output part 12-1 through the output part 12-3.

That is, in this embodiment, the UPS 4 has six power source outlets 231, and these six power source outlets 231 are partitioned into three sets comprising two power source outlets 231, and each of these three sets corresponds to each of the output part 12-1 through the output part 12-3.

And, as shown in FIG. 1, to one power source outlet 231 of the output part 12-1, the information processing apparatus 2-1 is connected through a power line 22-1, and to the other power source outlet 231, the information processing apparatus 2-2 is connected through a power line 22-2. In the same manner, to one power source outlet 231 of the output part 12-2, the information processing apparatus 2-3 is connected through a power line 22-3, and to the other power source outlet 231, the device 3-1 is connected through a power line 22-4. Also, to one power source outlet 231 of the output part 12-3, the device 3-2 is connected through a power line 22-5, but to the other power source outlet 231, nothing is connected.

Therefore, the UPS 4, in case that the commercial alternating current power source 5, which is an input power source, is normal, outputs electric power from this commercial alternating current power source 5 from the output part 12-1 to each of the information processing apparatus 2-1 and the information processing apparatus 2-2, and outputs it from the output part 12-2 to each of the information processing apparatus 2-3 and the device 3-1, and also, outputs it from the output part 12-3 to the device 3-2.

Also, the UPS 4, in case that there occurred something wrong with the commercial alternating current power source 5 which is an input power source, outputs electric power from a built-in battery (battery 216 of FIG. 9 which will be described later) from the output part 12-1 to each of the information processing apparatus 2-1 and the information processing apparatus 202, and outputs it from the output part 12-2 to each of the information processing apparatus 2-3 and the device 3-1, and outputs it from the output part 12-3 to the device 3-2.

Furthermore, the UPS 4 has a communication part 11, and, by utilizing this communication part 11, can carry out communication (transmit and receive information) with each of the information processing apparatus 2-1 through the information processing apparatus 2-3. In this regard, however, in this embodiment, as described later, all of control of output states of the output part 12-1 through the output part 12-3 of the UPS 4 are carried out by one unit of an information processing apparatus (in the example of FIG. 1, the information processing apparatus 2-1), and therefore, it is enough for the UPS 4 to simply carry out communication with the information processing apparatus 2-1 only. On this account, in FIG. 1, the communication part 11 of the UPS 4 is connected only to the information processing apparatus 2-1 through a communication lien 21.

Therefore, in this embodiment, the information processing apparatus 2-1 which carries out communication with the UPS 4 (information processing apparatus 2-1 which controls states of the output part 12-1 through the output part 12-3 of the UPS 4) is set as a master, and the information processing apparatus 2-2, and the information processing apparatus 2-3 other than it are set as slaves.

In addition, a communication system of communication which is carried out between the information processing apparatus (master) 2-1 and the UPS 4 (communication part 11) is not limited in particular, but in this embodiment, for example, it is made to be a wired or wireless serial communication system. Therefore, for example, in case of the wired serial communication system, the communication line 21 is made to be a cable implemented in relation to the serial communication system. In contrast to this, for example, in case of the wireless serial communication system, the communication line 21 is made to be wireless.

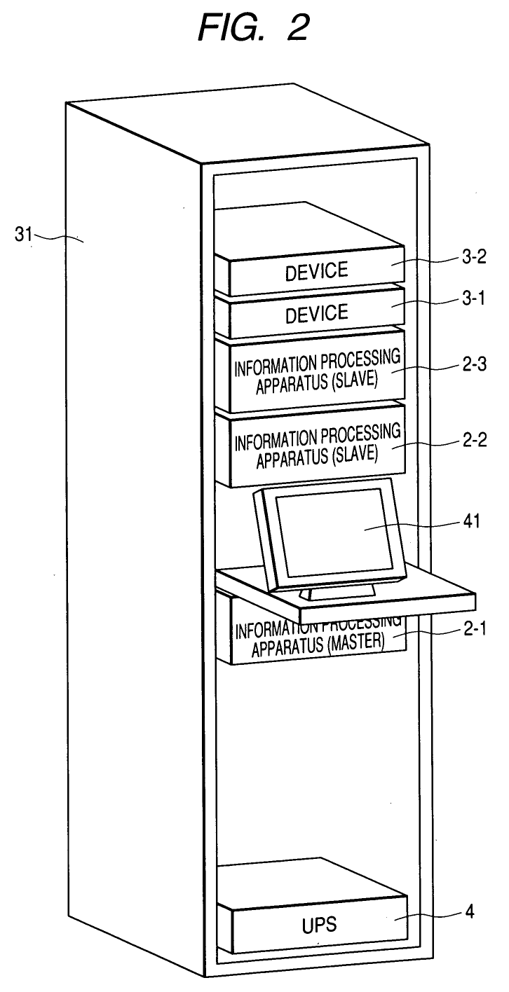

In this manner, in an information processing system of this embodiment, as an input power source (common power source) of each of the information processing apparatus 2-1 through the information processing apparatus 2-3, and the device 3-1 and the device 3-2, which are constituent elements thereof, one unit of the UPS 4 can be utilized. On this account, it becomes easily possible to accommodate all constituent elements of the information processing system in, for example, one rack 31 as shown in FIG. 2. By this, as compared to related art (such a case that UPSs, which are different from each other, were connected as respective input power sources of respective constituent elements of an information processing system), simplification of an installation space of an information processing system is realized, and convenience to a user of an information processing system is improved (e.g., it becomes possible for a user to make management easier than in the related art).

In addition, in this embodiment, with the aim of further simplification of an installation space and further improvement of convenience, as shown in FIG. 2, one unit of a display 41 is used both as respective display devices of the information processing apparatus 2-1 through the information processing apparatus 2-3.

However, as descried above, in case that the UPS 4 is utilized as a common power source of constituent elements of an information processing system, control of an electric power output of the UPS 4 is required to be unified control in consideration of an entirety of the information processing system, but, when each of the information processing apparatus 2-1 through the information processing apparatus 2-3 are controlled independently and the output part 12-1 or the output part 12-2 which was connected to itself is controlled individually, as in the related art, it becomes difficult to meet the suchlike need. That is, the same problem as in the related art will occur.

In this connection, in order to solve the suchlike problem, in this embodiment, as described above, only one unit of the information processing apparatus (master) 2-1 carries out communication with the UPS 4, and receives information which was transmitted from the UPS 4, and monitors a state of the UPS 4 on the basis of that information. And, the information processing apparatus (master) 2-1 only generates control information for individually controlling respective states of a plurality of the output part 12-1 through the output part 12-3 of the UPS 4, on the basis of a result of that monitoring, and transmits the control information to the UPS 4.

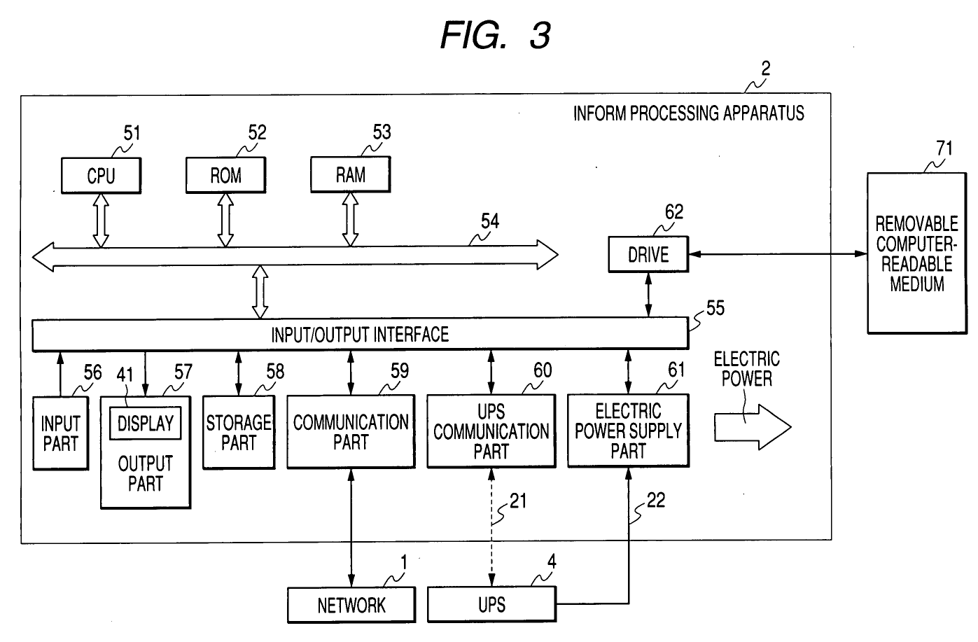

FIG. 3 represents a configuration example of the suchlike information processing apparatus (master) 2-1.

In addition, each of the information processing apparatus (slave) 2-2 and the information processing apparatus (slave) 2-3 is capable of communicating through the network 1, and of using the UPS 4 as a power source, and also, if it is of a form which is capable of carrying out shutdown processing, its form is not limited in particular. In this regard, however, in this embodiment, each of the information processing apparatus (slave) 2-2 and the information processing apparatus (slave) 2-3 has a function itself for carrying out communication with the UPS 4, and can be functioned as a master according to setup of a user.

In this connection, in this embodiment, any one of the information processing apparatus 2-1 through the information processing apparatus 2-3 has a configuration shown in FIG. 3, and hereinafter, in case that there is no necessity to individually explain each of the information processing apparatus 2-1 through the information processing apparatus 2-3 (in case of there is no necessity of differentiation), it is simply referred to as an information processing apparatus 2.

In the information processing apparatus 2 of FIG. 3, a CPU (Central Processing Unit) 51 carries out a variety of processing in accordance with programs which are recorded in a ROM (Read Only Memory) 52, or programs which were loaded from a storage part 58 to a RAM (Random Access Memory) 53. In the RAM 53, also, data etc. necessary for the CPU 51 to carry out a variety of processing is recorded arbitrarily.

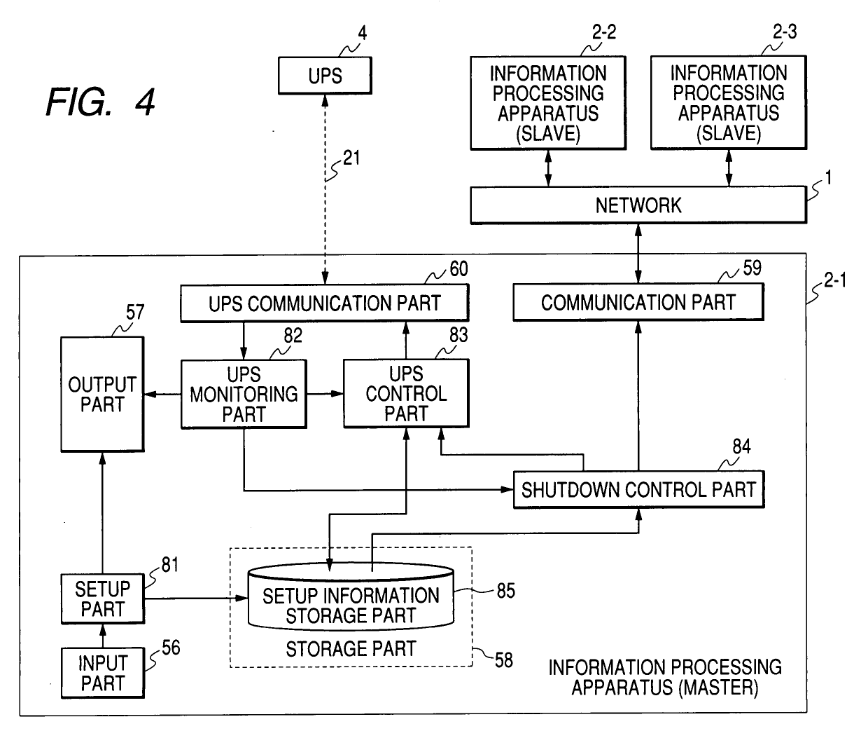

Concretely speaking, for example, it is possible to configure as each of a setup part 81, a UPS monitoring part 82, a UPS control part 83 and a shutdown control part 84, which are shown in FIG. 4 which will be described later, as a program. The CPU 51 has each function of the setup part 81, UPS monitoring part 82, UPS control part 83 and shutdown control part 84 carried out, by executing these programs.

The CPU 51, the ROM 52, and the RAM 53 are connected to each other through a bus 54. To this bus 54, an input/output interface 55 is also connected.

To the input/output interface 55, also connected are an input part 56 which is composed of a keyboard, a mouse etc., an output part 57 which is composed of the above-described display 41 etc. (in this regard, however, as shown in the above-described FIG. 2, the display 41 may be used also for another information processing apparatus), and a storage part 58.

The storage part 58 is composed of, for example, a hard disk etc. and stores programs and a group of data by which the information processing apparatus 2 functions. That is, the storage part 58 stores not only operating system and setup information, but also application software which is contingent upon them, or data such as sounds and images.

Concretely speaking, for example, as shown in FIG. 4, in case that each of the setup part 81, the UPS monitoring part 82, the UPS control part 83, and the shutdown control part 84 is configured as a program, in the storage part 58, programs for them (application software which is configured from programs etc. for them) are stored.

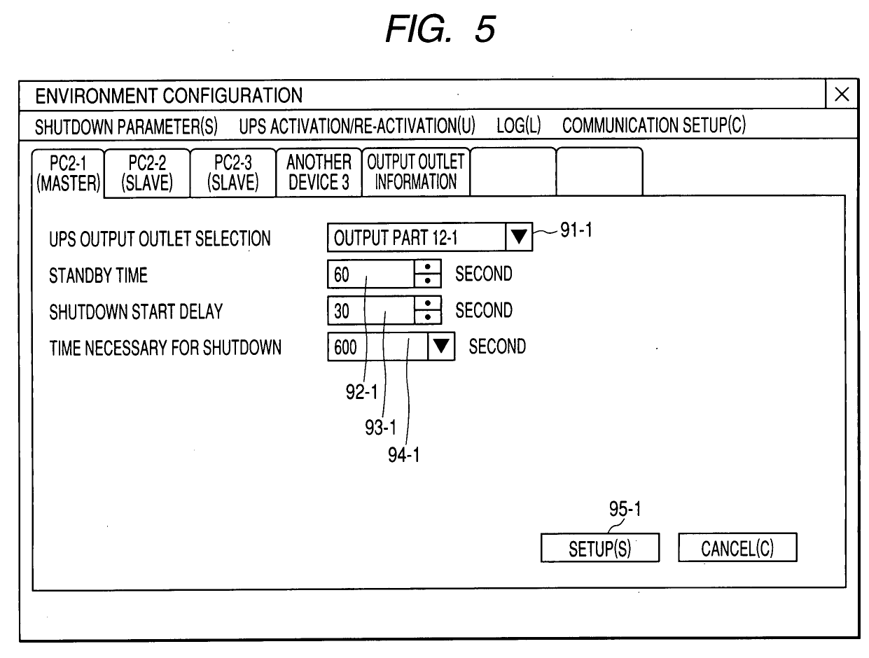

Also, a user, by utilizing images shown in FIG. 5 through FIG. 7 which will be described later, inputs setup information which is necessary for individually controlling respective output states of the output part 12-1 through the output part 12-3 of the UPS 4, but, in the storage part 58, the suchlike setup information is also stored. That is, a predetermined area of the storage part 58 corresponds to a setup information storage part 85 of FIG. 4 which will be described later.

To the input/output interface 55, a communication part 59, a UPS communication part 60, and an electric power supply part 61 are further connected.

The communication part 59 is composed of, for example, a modem, a terminal adapter, etc., and controls communication with another information processing apparatus (e.g., in case of having focused on the information processing apparatus (master) 2-1 of FIG. 1, the information processing apparatus (slave) 2-2 and the information processing apparatus (slave) 2-3) through the network 1. In addition, a communication system of the communication part 59 is not limited in particular, and may be a wired communication system, and may be a wireless communication system.

The UPS communication part 60 is composed of, for example, a communication board, a communication card etc. which was implemented in relation to the wireless or wired serial communication system, and controls communication with the UPS 4.

The electric power supply part 61 supplies electric power which was supplied from the UPS 4 through the power line 22 (in this manner, each of power line 22-1 through power line 22-3 is simply referred to as power line 22, in case that there is no specific necessity for differentiation) to each of respective parts in the information processing apparatus 2. That is, in FIG. 3, electric power which is supplied from the electric power supply part 61 is shown by an outline arrow on a colored background, but in reality, the electric power supply part 61 and each of respective part in the information processing apparatus 2 are connected, and the electric power supply part 61 applied a direct current voltage of a corresponding level individually to each of respective part in the information processing apparatus 2.

To the input/output interface 55, a drive 62 is also connected according to need, and a removable computer-readable medium 71, which is composed of a magnetic disk, an optical disk, an magneto-optical disk, or a semiconductor memory etc. is mounted arbitrarily, and a computer program which was read out from them is installed in the storage part 58 according to need.

In addition, the information processing apparatus 2 is of a configuration which is capable of carrying out communication with the UPS each other, and if it is of a form which is capable of monitoring and controlling the UPS 4 (i.e., in order to protect information etc. for carrying out the suchlike monitoring and control, generally, a form which requires execution of shutdown processing), its form is not limited to the example of FIG. 3, and is capable of taking a variety of forms. Concretely speaking, for example the information processing apparatus 2, can be also configured as a home electric appliance etc., in addition to a control device such as a PLC (Programmable Logic Controller), although it is not shown in the figure.

FIG. 4 is a functional block diagram showing a function for individually controlling respective output states of the output part 12-1 through the output part 12-3 of the UPS 4, in addition to monitoring a state of the UPS 4 connected as an input power source, out of functions which are possessed by the information processing apparatus 2, and controlling the above-described shutdown processing and UPS stop processing, according to a result of the monitoring.

The suchlike function can be realized, for example, as shown in FIG. 4, by hardware shown in the above-described FIG. 3 such as the input part 56, the output part 57, the storage part 58, the communication part 59, and the UPS communication part 60, and by software which is executed by the above-described CPU 51 of FIG. 3, such as the setup part 81, the UPS monitoring part 82, the UPS control part 83, and the shutdown control part 84.

In addition, in this embodiment, it was explained that since the information processing apparatus 2 is a computer which is configured as shown in FIG. 3, each of the setup part 81, the UPS monitoring part 82, the UPS control part 83, and the shutdown control part 84 is realized by software, but as a matter of course, all or a part of them may be configured by hardware, or may be configured by combination of software and hardware. In this regard, however, in this case, the information processing apparatus 2 is configured in such a manner that, for example, a block which is configured by hardware is further added to the configuration of FIG. 3.

The setup part 81 sets up each of preparation times necessary for preparation to shutoff of electric power from the UPS, which is carried out by each of loads of the UPS 4 (in this embodiment, as shown in FIG. 1, the information processing apparatus 2-1 through the information processing apparatus 2-3, and the device 3-1 and the device 3-2) on the basis of various setup information inputted from the input part 56. And, the setup part 81 has the setup information storage part 85 stored each preparation time of each load of the UPS 4 which was set up in this manner, and setup information which was inputted from the input part 56.

That is, the setup information storage part 85 (a predetermined area in the storage part 58) stores the setup information which is supplied from the setup part 81, and each preparation time of each load of the UPS 4.

Speaking in detail, for example, the setup part 81 has images for having various setup information inputted, which are shown in each of FIG. 5 through FIG. 7, displayed on the output part 57 (display 41).

FIG. 5 represents an image for having setup information, which is necessary for setup of preparation time etc. Of the information processing apparatus (master) 2-1, inputted.

That is, a user operates the input part 56, and inputs corresponding setup information, among the setup information which is necessary for setup of preparation time etc. of the information processing apparatus (master) 2-1, into each of a box 91-1 through a box 94-1 in the image of FIG. 5. And, when a user carries out a depressing operation of a setup button 95-1 (not shown in the figure, but such an operation that a pointer etc. of a mouse is located on the setup button 95-1, and the mouse is left-clicked, etc.), the setup part 81 fixes information which was inputted into each of the box 91-1 through the box 94-1 as setup information which is necessary for setup of preparation time of the information processing apparatus (master) 2-1, and stores it in the setup information storage part 85. Also, the setup part 81 sets the preparation time of the information processing apparatus (master) 2-1 from these setup information, and stores it in the setup information storage part 85. In addition, a setup method of the preparation time of the information processing apparatus (master) 2-1 will be described later.

Concretely speaking, in the image of FIG. 5, into the box 91-1 which is shown on the right side of display entitled “UPS OUTPUT OUTLET SELECTION”, inputted is an output part (in the example of FIG. 5, in compliance with FIG. 1, it is the output part 12-1) to which the information processing apparatus (master) 2-1 was connected, among the output part 12-1 through the output part 12-3 of the UPS 4.

Into the box 92-1 which is shown on the right side of display entitled “STANDBY TIME”, as described later, inputted is time between such a time point that there occurred something wrong with an input power source of the UPS 4 and such a time point that the information processing apparatus (master) 2-1 judges to carry out the shutdown processing (hereinafter, the suchlike time is referred to as standby time). That is, even if there occurred something wrong with an input power source (commercial alternating current power source 5) of the UPS 4, there is such a case that its abnormality is recovered within a short period of time, and in such a case, the shutdown processing is not necessary. Therefore, the information processing apparatus (master) 2-1, even if there occurred something wrong with an input power source of the UPS 4, waits for its processing (prohibits to judge the execution of the shutdown processing), during a period from a time point of that occurrence until the standby time has passed (in the example of FIG. 5, 60 seconds), and only in case that the abnormality of the input power source of the UPS 4 continues even after the standby time has passed, it judges to carry out the shutdown processing.

Into the box 93-1 which is shown on the right side of display entitled “SHUTDOWN START DELAY”, inputted is time from such a time point that the information processing apparatus (master) 2-1 judged to carry out the shutdown processing until it actually starts the shutdown processing (hereinafter, the suchlike time is referred to as delay time). For example, in the example of FIG. 5, since 30 seconds is inputted into the box 93-1, the information processing apparatus (master) 2-1 starts the shutdown processing, after 30 seconds have further passed from such a time point that it judged to carry out the shutdown processing (i.e., from such a time point that there occurred something wrong with an input power source of the UPS 4 until such a time point that the standby time (in the example of FIG. 5, 60 seconds) has passed).

A user can adjust start timing of respective shutdown processing of the information processing apparatus 2-1 through the information processing apparatus 2-3 by adjusting each of delay time of the information processing apparatus 2-1, delay time of another information processing apparatus 2-2 which will be described later and delay time of another information processing apparatus 2-3 (by inputting adjusted delay time as setup information), in this manner. By this, for example, it becomes possible to meet such a request that start of the shutdown processing of the information processing apparatus 2-1 which is a master is delayed if at all possible, and in advance, shutdown processing of a slave (the information processing apparatus 2-2 and the information processing apparatus 2-3) is intended to be initiated.

Into the box 94-1 which is shown on the right side of display entitled “TIME NECESSARY FOR SHUTDOWN”, inputted is time which is necessary for the information processing apparatus (master) 2-1 to start and complete the shutdown processing (hereinafter, the suchlike time is referred to as shutdown processing time). For example, in the example of FIG. 5, since 600 seconds is inputted into the box 94-1, the information processing apparatus (master) 2-1 starts the shutdown processing, after delay time (in the example of FIG. 5, 30 seconds) has further passed, from such a time point that it judged to carry out the shutdown processing (i.e., such a time point that standby time (in the example of FIG. 5, 60 seconds) has passed from such a time point that there occurred something wrong with an input power source of the UPS 4), and after that, completes the shutdown processing within 600 seconds.

In addition, there are many cases that actual processing time of shutdown processing of the information processing apparatus (master) 2-1 becomes time which is different from that of another information processing apparatus, due to the number of application software which is executed by the information processing apparatus (master) 2-1, and capability of the information processing apparatus (master) 2-1 itself, and so on. In this connection, it is fine if a user has the information processing apparatus (master) 2-1 actually executed the shutdown processing, and measures time which was required at that time (actual processing time of the shutdown processing), and inputs such time that predetermined window time was added to the measured time (actual processing time of the shutdown processing) into the box 94-1 as shutdown processing time (time which is necessary for shutdown).

In this manner, since preparation to electric power shutoff of the UPS 4 in the information processing apparatus (master) 2-1 points out the shutdown processing after all, preparation time points out such time that time between such a time point that the information processing apparatus (master) 2-1 judged to carry out the shutdown processing until it completes the shutdown processing, i.e., such time that the delay time (time which was inputted into the box 93-1) and the shutdown processing time (time which was inputted into the box 94-1) were added.

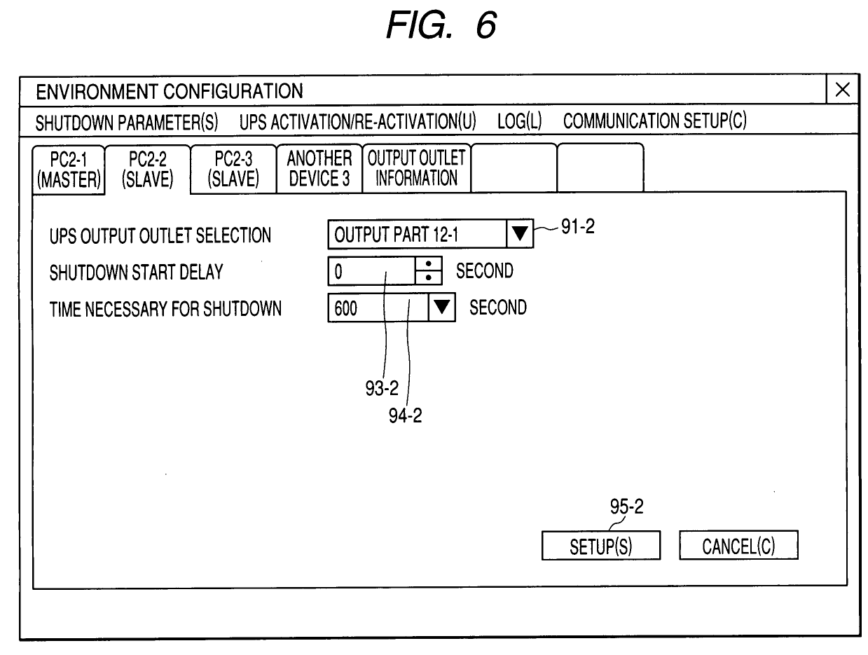

FIG. 6 represents an image for inputting setup information necessary for setup of preparation time etc. of another information processing apparatus (slave) 2-2.

That is, a user operates the input part 56, and inputs corresponding setup information, among setup information necessary for setup of preparation time etc. of another information processing apparatus (slave) 2-2, into each of the box 91-2, the box 93-2, and the box 94-2 in the image of FIG. 6. And, when a user carries out a depressing operation of the setup button 95-2, the setup part 81 fixes each of information which was inputted into each of the box 91-2, the box 93-2, and the box 94-2 as setup information necessary for setup of preparation time of another information processing apparatus (slave) 2-2, and stores it into the setup information storage part 85. Also, the setup part 81 sets up the preparation time of another information processing apparatus (slave) 2-2 from these setup information, and stores it into the setup information storage part 85. In addition, a setup method of preparation time of another information processing apparatus (slave) 2-2 will be described later.

Concretely speaking, in the image of FIG. 6, into the box 91-2 which is shown on the right side of display entitled “UPS OUTPUT OUTLET SELECTION”, inputted is an output part (in FIG. 6, in compliance with FIG. 1, it is the output part 12-1) to which another information processing apparatus (slave) 2-2 was connected, among the output part 12-1 through the output part 12-3 of the UPS 4.

Into the box 93-2 which is shown on the right side of display entitled “SHUTDOWN START DELAY”, inputted is delay time in another information processing apparatus (slave) 2-2.

For example, as described later, the information processing apparatus (master) 2-1 transmits an instruction (hereinafter, it is referred to as shutdown instruction) for starting the shutdown processing after this delay time (which is time inputted into the box 93-2, and in the example of FIG. 6, 0 second), to another information processing apparatus (slave) 2-2, at such a time point that it judged to carry out the shutdown processing (i.e., such a time point that the delay time (in the example of FIG. 5, 60 seconds) has passed from such a time point that there occurred something wrong with an input power source (commercial alternating current power source 5) of the UPS 4. In addition, at this time, at almost the same time, the information processing apparatus (master) 2-1 also transmits a similar shutdown instruction to another information processing apparatus (slave) 2-3.

And, another information processing apparatus (slave) 2-2 starts the shutdown processing after delay time, which is designated in the shutdown instruction, has passed from such a time point that it received this shutdown instruction (i.e., in the example of FIG. 6, since 0 second is designated as delay time, at such a time point that the shutdown instruction was just received).

Into the box 94-2 which is shown on the right side of display entitled “TIME NECESSARY FOR SHUTDOWN”, inputted is shutdown processing time of another information processing apparatus (slave) 2-2. For example, in the example of FIG. 6, since 600 seconds is inputted into the box 94-2, another information processing apparatus (slave) 2-2 starts the shutdown processing after delay time has passed (i.e., in the example of FIG. 6, since 0 second is designated as delay time, at such time point that the shutdown instruction was just received), from such a time point that it judged to carry out the shutdown processing (i.e., such a time point that the shutdown instruction was received from the information processing apparatus (master) 2-1), and after that, completes the shutdown processing within 600 seconds.

In addition, in the examples of FIG. 5 and FIG. 6, each shutdown processing time (time necessary for shutdown) of the information processing apparatus (master) 2-1 and another information processing apparatus (slave) 2-2 is set to be 600 seconds, but in the same manner as in the above-described information processing apparatus (master) 2-1, there are many cases in general that actual processing time for the shutdown processing of another information processing apparatus (slave) 2-2 becomes time which is different from that of another information processing apparatus. In this connection, it is fine if a user actually carries out shutdown processing also to another information processing apparatus (slave) 2-2, and measures time which was required at that time (actual processing time of shutdown processing), and inputs such time that predetermined window time was added to the measured time (actual processing time of the shutdown processing) into the box 94-2 as shutdown processing time (time necessary for shutdown).

In this manner, in the same manner as in the information processing apparatus (master) 2-1, even in another information processing apparatus (slave) 2-2, preparation to power shutoff of the UPS 4 points out the shutdown processing after all, preparation time points out such time that time between such a time point that another information processing apparatus (slave) 2-2 judged to carry out the shutdown processing (i.e., such a time point that the shutdown instruction was received from the information processing apparatus (master) 2-1) until it completes the shutdown processing, i.e., such time that the delay time (time which was inputted into the box 93-2) and the shutdown processing time (time which was inputted into the box 94-2) were added.

In addition, although it is not shown in the figure, an image for inputting setup information necessary for setup of preparation time etc. of another information processing apparatus (slave) 2-3 is also an image which is completely the same as the image shown in FIG. 6.

That is, a user operates the input part 56, and inputs corresponding setup information, among the setup information which is necessary for setup of preparation time of another information processing apparatus (slave) 2-3, into each of not-shown boxes (in FIG. 6, the box 91-2, the box 93-2, and the box 94-2) in an image which is the same as in FIG. 6.

In addition, at that time, it is fine if a user actually carries out the shutdown processing alto to another information processing apparatus (slave) 2-2, and measures time which was required at that time (actual processing time of the shutdown processing), and inputs such time that predetermined window time was added to the measured time (actual processing time of the shutdown processing) into a not-shown box, which corresponds to the box 94-2, as shutdown processing time (time necessary for shutdown).

And, when a user carries out a depressing operation of a not-shown setup button (button which corresponds to the setup button 95-2 of FIG. 6), the setup part 81 fixes information which was inputted into each box as setup information which is necessary for setup of preparation time of another information processing apparatus (slave) 2-3, and stores it in the setup information storage part 85. Also, the setup part 81 sets the preparation time of another information processing apparatus (slave) 2-3 from these setup information, and stores it in the setup information storage part 85.

At this time, the setup part 81 sets up the preparation time of another information processing apparatus (slave) 2-3, by use of completely the same setup method as the above-described setup method of the preparation time of another information processing apparatus (slave) 2-2. That is, in completely the same manner as in another information processing apparatus (slave) 2-2, even in another information processing apparatus (slave) 2-3, preparation to electric power shutoff of the UPS 4 points out the shutdown processing after all, and therefore, preparation time points out such time that time between such a time point that another information processing apparatus (slave) 2-3 judged to carry out the shutdown processing (i.e., such a time point that the shutdown instruction was received from the information processing apparatus (master) 2-1) until it completes the shutdown processing, i.e., such time that the delay time (time which was inputted into a not-shown box, which corresponds to the box 93-2 of FIG. 6) and the shutdown processing time (time which was inputted into a not-shown box, which corresponds to the box 94-2 of FIG. 6) were added.

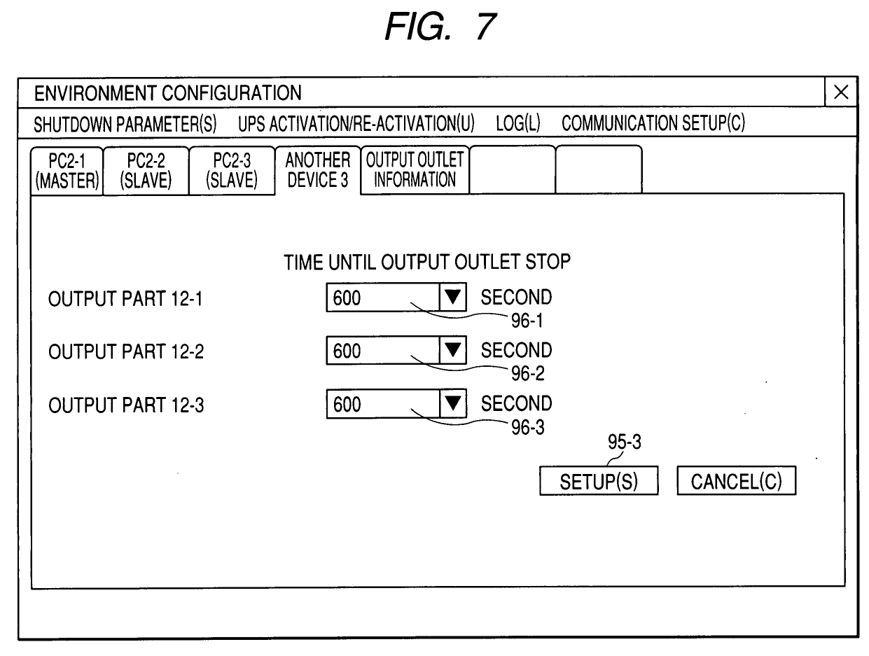

FIG. 7 represents an image for inputting setup information necessary for setup of preparation time etc. of a device (in this embodiment as shown in FIG. 1, the device 3-1 which was connected to the output part 12-2 and the device 3-2 which was connected to the output part 12-3) which was connected to each of the output part 12-1 through the output part 12-3 of the UPS 4.

That is, a user operates the input part 56, and inputs setup information necessary for setup of preparation time of a device which was connected to each of the output part 12-1 through the output part 12-3 of the UPS, respectively, into each of a box 96-1 through a box 96-3 in an image of FIG. 7. And, when a user carries out a depressing operation of the setup button 95-3, the setup part 81 fixes each of information which was inputted into each of the box 96-1 through the box 96-3 as setup information which is necessary for setup of preparation time of the device which was connected to each of the output part 12-1 through the output part 12-3, and stores it in the setup information storage part 85.

Also, the setup part 81 sets up preparation time of the device which was connected to each of the output part 12-1 through the output part 12-3, from these setup information, and stores it in the setup information storage part 85. In this regard, however, in this embodiment, the setup part 81 stores each of the information which was inputted into each of the box 96-1 through the box 96-3 into the setup information storage part 85 (by setting up) as preparation time of the device which was connected to each of the output part 12-1 through the output part 12-3.

That is, into each of the box 96-1 through the box 96-3 which is shown on the lower side of display entitled “TIME UNTIL OUTLET OUTPUT STOP”, inputted is preparation time of the device which was connected to each of the output part 12-1 through the output part 12-3. For example, in the example of FIG. 6, since 600 seconds is inputted into the output part 12-2, as preparation time of the device 3-1 which was connected to the output part 12-2, 600 seconds is setup. In the same manner, since 600 seconds is inputted into the output part 12-3, as preparation time of the device 3-2 which was connected to the output part 12-3, 600 seconds is set up.

In addition, the device 3-1 and the device 3-2 have no particular problem even if electric power from the UPS 4 is shut off, in case that they are operated by themselves, in general. Therefore, there exists no preparation to electric power shutoff to the UPS 4 in particular, in commonly used device 3-1 and device 3-2.

However, in case that the device 3-1 and the device 3-2 are operated in association with the information processing apparatus 2 (at least one of the information processing apparatus 2-1 through the information processing apparatus 2-3), when power states of the device 3-1 and the device 3-2 are turned to OFF states before shutdown processing of the associated information processing apparatus 2 is completed, there is such a case that various problems occur. Concretely speaking, for example, when the device 3-2 is an external had disk of the information processing apparatus 2-1, when a power state of the external hard disk is turned to an OFF state before shutdown processing of the information processing apparatus 2-1 is completed, it means to the information processing apparatus 2-1 that a place for evacuating (storing) data disappears suddenly, and as a result, there occurs such a problem that the data is lost.

In this connection, preparation to electric power shutoff of the UPS 4, in the device 3-1 and the device 3-2, is defined that an operating state is maintained (a power state is maintained as an ON state without change) until shutdown processing of the associated information processing apparatus 2 is completed, and a user, for example, can input time which is the same as the preparation time (time from such a point that the associated information processing apparatus 2 judges to carry out shutdown processing until it completes the shutdown processing) of the associated information processing apparatus 2, into the box 96-2 or the box 96-3, as preparation time in the device 3-1 and the device 3-2.

In this manner, by introducing a concept of preparation time, alto to a device which is configured as a router, a switching hub, or an external hard disk etc. (in this embodiment, the device 3-1 and the device 3-2 of FIG. 1), as described later, it becomes possible to control an output state of an output part for which a device only is a load (in this embodiment, as shown in FIG. 1, the output part 12-3 to which the device 3-2 was connected). Also, it becomes possible to control an output state of an output part for which a device and an information processing apparatus are mixed as a load (in this embodiment, as shown in FIG. 1, the output part 12-2 to which the information processing apparatus (slave) 2-3 and the device 3-1 were connected), adding a tinge of a feature of the device as well as a feature of the information processing apparatus.

By realizing the foregoing, the setup part 81 of one unit of the information processing apparatus (master) 2-1 can display an image for inputting setup information, as shown in FIG. 5 through FIG. 7, and thereby, a user can input setup information with a simple operation, and it becomes possible to suppress frequency of occurrence of a problem such as an inputting error.

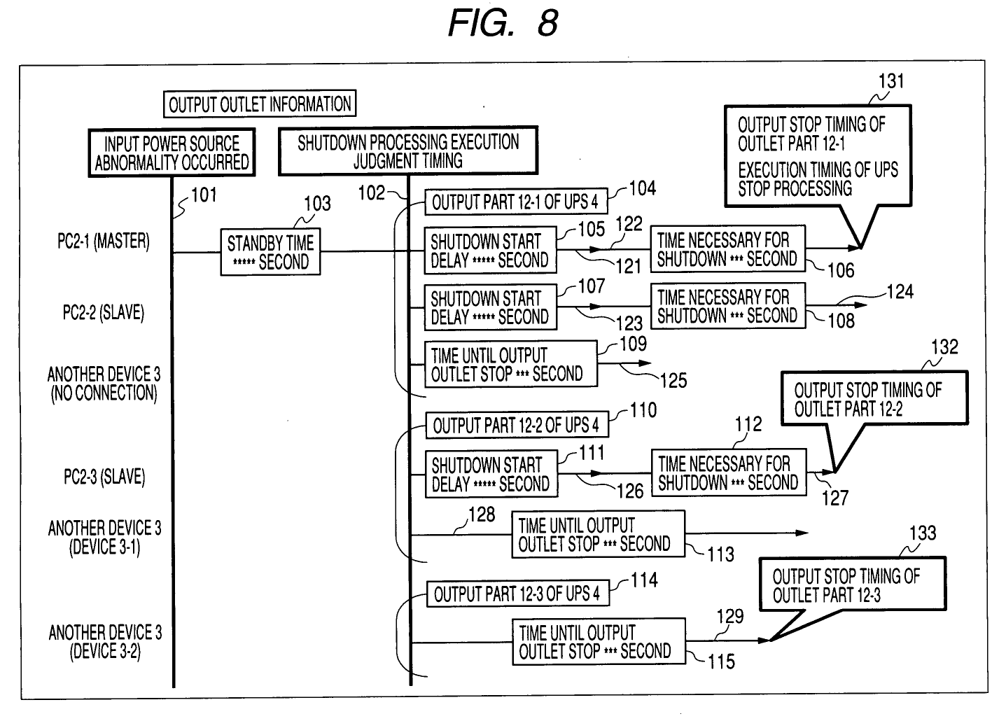

After that, that is, when all of setup information and preparation time, in each constituent element of an information processing system (each load of the UPS 4), are stored in the setup information storage part 85, the setup part 81 displays an image as shown in FIG. 8 on the output part 57 (display 41).

That is, FIG. 8 represents an image showing each timing chart of each load of the UPS 4 (each load which was connected to each output outlet 231 (FIG. 10) of the UPS 4), in case that there occurred something wrong with an input power source of the UPS 4 (hereinafter, the suchlike image is referred to as output outlet information image). That is, in this embodiment, as shown in FIG. 8, respective timing charts (output outlet information) of the information processing apparatus (master) 2-1 (in the example of FIG. 8, displayed as PC 2-1 (master)), the information processing apparatus (slave) 2-2 (in the example of FIG. 8, displayed as PC2-2 (slave)), the information processing apparatus (slave) 2-3 (in the example of FIG. 8, displayed as PC2-3 (slave)), the device 3-1 and the device 3-2 are displayed on the display 41.

In addition, detailed description of the output outlet information image of FIG. 8 will be described later but, it becomes easily possible for a user, by taking a look at this output outlet information image, to unify the management of a state of a load which was connected to each of the output part 12-1 through the output part 12-3 of the UPS 4 (power system of an information processing system, preparation time of each load). That is, a user, in case of working out a design of control of electric power output of the UPS 4, can easily work out such a design that unified control is realized in consideration of an entire information processing system.

Concretely speaking, for example, a user, by taking a look at the output outlet information image of FIG. 8, can easily figure out such a fact that two units of the information processing apparatus 2-1 and the information processing apparatus 2-2 are connected to the output part 12-1, and a corresponding relation of the information processing apparatus 2-1 and the information processing apparatus 2-2 (difference of respective preparation times) etc.

Therefore, a user, in case of changing a configuration of an information processing system (e.g., as a load of the UPS 4, a not-shown new information processing apparatus and a device are added) and of changing any one function of the information processing apparatus 2-1 through the information processing apparatus 2-3 (e.g., software is added), can easily redesign preparation time of each load of the UPS 4, over taking a look at the output outlet information image of FIG. 8.

Furthermore, a user can easily carry out an input operation of setup information which corresponds to the redesigned preparation time, by utilizing the images of FIG. 5 through FIG. 7, as described above, and it becomes possible to suppress frequency of occurrence of a problem such as an inputting error.

Returning to FIG. 4, the UPS monitoring part 82 monitors a state of the UPS 4 on the basis of various information which was transmitted from the UPS 4 and received by the UPS communication part 60, and provides a result of the monitoring to each of the output part 57, the UPS control part 83, and the shutdown control part 84.

Then, the output part 57 outputs the result of the monitoring (e.g., the display 41 displays an image which shows the result of the monitoring), and the UPS control part 83 generates control information for individually controlling respective states of the output part 12-1 through the output part 12-3 of the UPS 4, and carries out control for having the UPS communication part 60 transmitted to the UPS 4. Also, the shutdown control part 84, on the basis of the result of the monitoring of the UPS monitoring part 82, controls shutdown processing of the information processing apparatus (master) 2-1 itself, and also, controls respective shutdown processing of another information processing apparatus (slave) 2-2 and another information processing apparatus (slave) 2-3 through the communication part 59 and the network 1 (generates the above-described shutdown instruction, and carries out control for having each of the information processing apparatus (slave) 2-2 and the information processing apparatus (slave) 2-3 transmitted through the communication part 59 and the network 1).

Concretely speaking, for example, the UPS 4, as described later, in case that there occurred something wrong, transmits information which shows that abnormality to the information processing apparatus (master) 2-1.

In the information which shows the abnormality, roughly speaking, there exist two types such as information which shows abnormality of the UPS 4 itself (e.g., abnormality etc. of a battery 216 of FIG. 9 which will be described later), and information which shows abnormality of an input power source (commercial alternating current power source 5 of FIG. 1).

In addition, hereinafter, the information of the latter type out of the information which shows abnormality, i.e., the information which shows abnormality of an input power source is referred to as “INPUT POWER SOURCE ABNORMALITY”.

For example, incase that the UPS 4 transmitted the suchlike “INPUT POWER SOURCE ABNORMALITY”, the UPS monitoring part 82 gives notice of such a monitoring result that there occurs something wrong with an input power source of the UPS 4 to each of the UPS control part 83 and the shutdown control part 84.

Then, the UPS control part 83 determines stop timing for stopping an output of the output part 12-1 of the UPS 4, on the basis of preparation time (in this embodiment, as shown in FIG. 1, preparation time of the information processing apparatus (master) 2-1 itself, and preparation time of the information processing apparatus (slave) 2-2) of a load which was connected to the output part 12-1, among preparation times stored in the setup information storage part 85.

In the same manner, the UPS control part 83 determines stop timing of the output part 12-2 of the UPS 4, on the basis of preparation time (in this embodiment, as shown in FIG. 1, preparation time of the information processing apparatus (slave) 2-3, and preparation time of the device 3-1) of a load which was connected to the output part 12-2, among preparation times stored in the setup information storage part 85. Also, the UPS control part 85 determines stop timing of the output part 12-3 of the UPS 4, on the basis of preparation time (in this embodiment, as shown in FIG. 1, preparation time of the device 3-2) of a load which was connected to the output part 12-3, among preparation times stored in the setup information storage part 85.

Here, an example of a determining method of respective stop timings of the output part 12-1 through the output part 12-3 of the UPS 4 will be described with reference to the output outlet information image of FIG. 8.

In this connection, firstly, detail of the output outlet information image of FIG. 8 will be described.

As described above, in the output outlet information image of FIG. 8, respective timing charts of loads which were connected to the output part 12-1 through the output part 12-3 of the UPS 4 respectively are shown in that order.

Concretely speaking, for example, a timing chart of a load which was connected to the output part 12-1 of the UPS 4 is displayed in a range which is shown by display 104 entitled “OUTPUT PART 12-1 OF UPS 4”. That is, as shown in FIG. 8, as a timing chart of a load which was connected to the output part 12-1, shown are respective timing charts of the information processing apparatus (master) 2-1 (in the example of FIG. 8, displayed as PC2-1 (master)), and the information processing apparatus (slave) 2-2 (in the example of FIG. 8, displayed as PC2-2 (slave)).

In addition, in this embodiment, a device is not actually connected to the output part 12-1 of the UPS 4, but since preparation time (time until outlet stop) of a device, in case that the device was supposedly connected to the output part 12-1, is inputted into the above-described box 96-1 of FIG. 7, a timing chart of a device (in the example of FIG. 8, displayed as another device 3 (no connection)) which is not actually connected is also displayed, in the output outlet information image of FIG. 8.

In the same manner, for example, a timing chart of a load which was connected to the output part 12-2 of the UPS 4 is displayed in a range which is shown by display 110 entitled “OUTPUT PART 12-2 OF UPS 4”. That is, as shown in FIG. 8, as a timing chart of a load which was connected to the output part 12-2, shown are respective timing charts of the information processing apparatus (slave) 2-3 (in the example of FIG. 8, displayed as PC2-3 (slave)), and the device 3-1 (in the example of FIG. 8, displayed as another device 3 (device 3-2)).

Also, for example a timing chart of a load which was connected to the output part 12-3 of the UPS 4 is displayed in a range which is shown by display 114 entitled “OUTPUT PART 12-3 OF. UPS 4”. That is, as shown in FIG. 8, as a timing chart of a load which was connected to the output part 12-3, shown is a timing charts of the device 3-2 (in the example of FIG. 8, displayed as another device 3 (device 3-2)).

In addition, a time axis is not shown in particular, in the output outlet information image of FIG. 8, but a horizontal direction (i.e., in FIG. 8, horizontal direction) of a screen of the display 41 is set as a time axis, and a direction of a flow of time is set to be a direction which is moving from left to right of the screen. Also, a base point of the time axis is set to be such a time point (time point that display 101 entitled “INPUT POWER SOURCE ABNORMALITY OCCURRED” is shown, in FIG. 8) that the information processing apparatus (master) 2-1 received “INPUT POWER SOURCE ABNORMALITY” from the UPS 4.

As described above, the information processing apparatus (master) 2-1 judges to carry out shutdown processing, in case that it has been still receiving “INPUT POWER SOURCE ABNORMALITY” from the UPS 4, at such a time point that predetermined standby time (time which was inputted into the box 92-1 of FIG. 5) after it received “INPUT POWER SOURCE ABNORMALITY” from the UPS 4 for the first time.

By realizing the foregoing, such a time point that the information processing apparatus (master) 2-1 judges to carry out the shutdown processing is shown by display 102 entitled “SHUTDOWN PROCESSING EXECUTION JUDGMENT TIMING”, in FIG. 8. also, standby time at this time is shown by display 103 entitled “STANDBY TIME SECOND”, on a timing chart of “PC2-1 (master)”, in FIG. 8, and also, a straight line of length which corresponds to this standby time is displayed. That is, an interval between the display 101 entitled “INPUT POWER SOURCE ABNORMALITY OCCURRED” and the display 102 entitled “SHUTDOWN PROCESSING EXECUTION JUDGMENT TIMING” is disposed with the length which corresponds to this standby time.

As described above, the information processing apparatus (master) 2-1 starts shutdown processing of itself, at such a time point that only delay time (time which was inputted into the box 93-1 of FIG. 5) has passed from such a time point that it judged to carry out shutdown processing, and after that, completes the shutdown processing, when shutdown processing time (time which was inputted into the box 94-1 of FIG. 5) has almost passed.

The delay time at this time is shown by display 105 entitled “SHUTDOWN START DELAY SECOND” on the timing chart of “PC2-1 (master)”, in FIG. 8, and an arrow 121 of length which corresponds to this delay time is shown.

Also, the shutdown processing time at this time is shown by display 106 entitled “TIME NECESSARY FOR SHUTDOWN SECOND”, on the timing chart of “PC2-1 (master)”, in FIG. 8, and an arrow 122 of length which corresponds to this shutdown processing time is shown.

That is, such length (length from the display 102 of “SHUTDOWN PROCESSING EXECUTION JUDGMENT TIMING” until a tip (end of a tip which is pointed up) of the arrow 122) that length of the arrow 121 which corresponds to the delay time of the information processing apparatus (master) 2-1 and length of the arrow 122 which corresponds to the shutdown processing time of the information processing apparatus (master) 2-1 were added is to represent preparation time of the information processing apparatus (master) 2-1.

In this manner, in the output outlet information image of FIG. 8, setup information of the information processing apparatus (master) 2-1, which was inputted by a user with utilizing the image of FIG. 5, is expressed in the form of a timing chart, and therefore, it becomes easily possible for a user to visually recognize setup information of the information processing apparatus (master) 2-1, and preparation time which is determined by those setup information, by taking a look at this timing chart.

In the same manner, in the output outlet information image of FIG. 8, by the images of FIG. 6 and FIG. 7 (or, image for inputting setup information of the information processing apparatus (slave) 2-3, which corresponds to FIG. 6), inputted setup information (i.e., respective setup information of the information processing apparatus (slave) 2-2, the information processing apparatus (slave) 2-3, the device 3-1, and the device 3-2) of other loads of the UPS 4 is also expressed in the form of respective timing charts of other loads of the UPS 4. Therefore, it becomes easily possible for a user to visually recognize respective setup information and preparation time of other loads of the UPS, by taking a look at these timing charts.

Concretely speaking, for example, on the timing chart of the information processing apparatus (slave) 2-2, as delay time of the information processing apparatus (slave) 2-2, time which was inputted into the box 93-2 of FIG. 6 is shown by display 107 entitled “SHUTDOWN START DELAY SECOND”, and also an arrow 123 of length which corresponds to this delay time is shown.

Also, as shutdown processing time of the information processing apparatus (slave) 2-2, time which was inputted into the box 94-2 of FIG. 6 is shown by display 108 entitled “TIME NECESSARY FOR SHUTDOWN SECOND”, and also an arrow 124 of length which corresponds to this shutdown processing time is shown.

That is, such length (length from the display 102 of “SHUTDOWN PROCESSING EXECUTION JUDGMENT TIMING” until a tip of the arrow 124) that length of the arrow 123 which corresponds to the delay time of the information processing apparatus (slave) 2-2 and length of the arrow 124 which corresponds to the shutdown processing time of the information processing apparatus (slave) 2-2 were added is to represent preparation time of the information processing apparatus (slave) 2-2.

Also, for example, on the timing chart of the information processing apparatus (slave) 2-3, as delay time of the information processing apparatus (slave) 2-3, time which was inputted into a not-shown box which corresponds to the box 93-2 of FIG. 6 is shown by display 111 entitled “SHUTDOWN START DELAY SECOND”, and also an arrow 126 of length which corresponds to this delay time is shown.

As shutdown processing time of the information processing apparatus (slave) 2-3, time which was inputted into a not-shown box which corresponds to the box 94-2 of FIG. 6 is shown by display 112 entitled “TIME NECESSARY FOR SHUTDOWN SECOND”, and also an arrow 127 of length which corresponds to this shutdown processing time is shown.

That is, such length (length from the display 102 of “SHUTDOWN PROCESSING EXECUTION JUDGMENT TIMING” until a tip of the arrow 127) that length of the arrow 126 which corresponds to delay time of the information processing apparatus (slave) 2-3 and length of the arrow 127 which corresponds to shutdown processing time of the information processing apparatus (slave) 2-3 were added is to represent preparation time of the information processing apparatus (slave) 2-3.

Also, for example, on the timing chart of the device 3-1, as preparation time of the device 3-1, preparation time which was inputted into the box 96-2 of FIG. 7 is shown by display 113 entitled “TIME UNTIL OUTPUT OUTLET STOP SECOND”, and also an arrow 128 of length which corresponds to this preparation time is shown.

In the same manner, for example, on the timing chart of the device 3-2, as preparation time of the device 3-2, preparation time which was inputted into the box 96-3 of FIG. 7 is shown by display 115 entitled “TIME UNTIL OUTPUT OUTLET STOP SECOND”, and also an arrow 129 of length which corresponds to this preparation time is shown.

In addition, as described above, a device is not connected to the actual output part 12-1 of the UPS 4, but since predetermined time is inputted into the box 96-1 of FIG. 7, on a timing chart of another device 3 (no connection) in the output part 12-1, time which was inputted into the box 96-1 of FIG. 7 is shown by display 109 entitled “TIME UNTIL OUTPUT OUTLET STOP SECOND”, and also, an arrow 125 of length which corresponds to this time is shown.

As known from the suchlike output outlet information image of FIG. 8, for example, at such a time point that the information processing apparatus (slave) 2-2 completed shutdown processing (i.e., time point which corresponds to a tip of the arrow 124 of FIG. 8), the information processing apparatus (master) 2-1 is still in the process of carrying out shutdown processing. Therefore, when an output state of the output part 12-1 of the UPS 4 is moved to a stop state at such a time point that the information processing apparatus (slave) 2-2 completed shutdown processing, supply of electric power is to be suddenly shut off, in the information processing apparatus (master) 2-1, and there occurs such problems that information which was processed at that time point is damaged and lost, and in addition, the information processing apparatus (master) 2-1 itself (e.g., storage part 58 of FIG. 3 which is composed of a hard disk etc.) is broken down.

Therefore, in order to solve the suchlike problems, there is a necessity to make output stop timing of the output part 12-1 of the UPS 4 such a time point that the information processing apparatus (master) 2-1 has completed shutdown processing (i.e., time point which corresponds to a tip of the arrow 122 of FIG. 8), or a time point from then on.

That is, there is such a necessity that output stop timing of the output part 12-1 of the UPS 4 is set to be “such a time point that at least preparation time of maximum length (in FIG. 8, preparation time of the information processing apparatus (master) 2-1, which corresponds to such length that length of the arrow 122 whose tip is located at the right most side, and length of the arrow 121 were added), among respective preparation times of the information processing apparatus (master) 2-1 and the information processing apparatus (slave) 2-2 which were connected to the output part 12-1, has passed from such time point that the information processing apparatus (master) 2-1 judged to start shutdown processing”.

In this connection, in this embodiment, the UPS control part 83 of FIG. 4 determines that “such a time point that preparation time of the information processing apparatus (master) 2-1 has passed, from such a time point that the information processing apparatus (master) 2-1 judged to start shutdown processing” is stop timing of the output part 12-1 of the UPS 4.

In the same manner, there is such a necessity that output stop timing of the output part 12-2 of the UPS 4 is set to be “such a time point that at least preparation time of maximum length, among respective preparation times of the information processing apparatus (slave) 2-3 and the device 3-1 (in the example of FIG. 8, either preparation time is to be identical), has passed from such time point that the information processing apparatus (master) 2-1 judged to start shutdown processing”.

In this connection, in this embodiment, the UPS control part 83 determines that “such a time point that preparation time of the information processing apparatus (slave) 2-3 (in FIG. 8, time which corresponds to such length that length of the arrow 126 which shows delay time of the information processing apparatus (slave) 2-3 and length of the arrow 127 which shows shutdown processing time of the information processing apparatus (slave) 2-3 were added) has passed from such a time point that the information processing apparatus (master) 2-1 judged to start shutdown processing”, or, “such a time point that preparation time of the device 3-1 (in FIG. 8, time which corresponds to length of the arrow 128) from such a time point that the information processing apparatus (master) 2-1 judged to start shutdown processing” is stop timing of the output part 12-2 of the UPS 4.

Also, since only the device 3-2 is connected to the output part 12-3 of the UPS 4, in the suchlike case, in this embodiment, the UPS control part 83 determines that “such a time point that preparation time of the device 3-2 (in FIG. 8, time which corresponds to length of the arrow 129) has passed from such a time point that the information processing apparatus (master) 2-1 judged to start shutdown processing” is stop timing of the output part 12-3 of the UPS 4.

In this manner, the UPS control part 83 determines respective stop timings of the output part 12-1 through the output part 12-3 of the UPS 4, on the basis of preparation time of maximum length among preparation time of its load.

Furthermore, the UPS control part 83, on the basis of the preparation time of maximum length among preparation time of all loads of the UPS 4, also determines execution timing of stop processing of the above-described UPS. For example, in this embodiment, as shown in FIG. 8, the preparation time of maximum length among preparation time of all loads of the UPS 4 is to be preparation time of the information processing apparatus (master) 2-1 (in FIG. 8, time which corresponds to such time that length of the arrow 122 whose tip is located at the right most side and length of the arrow 121 were added).

In this connection, in this embodiment, the UPS control part 83 determines that “such a time point that preparation time of the information processing apparatus (master) 2-1 has passed from such a time point that the information processing apparatus (master) 2-1 judged to start shutdown processing” is execution timing of UPS stop processing of the UPS 4.

That is the execution timing of the UPS stop processing of the UPS 4 coincides with latest timing (in the example of FIG. 8, stop timing of the output part 12-1 of the UPS 4) among stop timings of the output part 12-1 through the output part 12-3 of the Ups 4.

By realizing the foregoing, the UPS control part 83 determines respective stop timings of the output part 12-1 through the output part 12-3 of the UPS 4, and execution timing of UPS stop processing, when it is monitored by the UPS monitoring part 82 that there occurs something wrong with an input power source (commercial alternating current power source 5 of FIG. 1) of the UPS 4.

After that, the UPS control part 83 generates control information including at least respective stop timings of the output part 12-1 through the output part 12-3 of the UPS 4, and execution timing of UPS stop processing (hereinafter, the suchlike control information is referred to stop instruction). And, the UPS control part 83, when execution start of shutdown processing is notified from the shutdown control part 84 (as described later, this notification is carried out at such a time point that the above-described standby time has passed, from such a time point that it was monitored by the UPS monitoring part 82 that something wrong is occurring in an input power source of the UPS 4), carries out control for transmitting a previously generated stop instruction from the UPS communication part 60 to the UPS 4.

The UPS 4, when it receives this stop instruction, transfers (individually transfers) respective states of outputs of electric power of the output part 12-1 through the output part 12-3 to stop state sequentially at stop timing which is included in that stop instruction (latest timing among stop timings of the output part 12-1 through the output part 12-3 of the UPS 4), and finally, carries out UPS stop processing at execution timing of UPS stop processing which is included in that stop instruction (in this embodiment, the same timing as stop timing of the output part 12-1).

In this manner, the UPS 4 is controlled by the information processing apparatus (master) 2-1 (receives control information such as a stop instruction which is transmitted from it), and thereby, in case that there occurred something wrong with its input power source, it is possible to transfer a state of an output part 12-n (in this regard, however, in this embodiment, n is any value out of 1 through 3) to a stop state (such a state that an output of electric power is stopped), at appropriate timing such as “such a time point that all of a plurality of loads which were connected to the output part 12-n completed preparation to power-off”. That is, the UPS 4 can transfer a state of the output part 12-n, independently from an output state of another output part 12-m (in this embodiment, m is each of two values out of 1 through 3 except for n).

Also, the UPS 4 is controlled by the information processing apparatus (master) 2-1 (receives control information such as a stop instruction which is transmitted from it), and thereby, in case that there occurred something wrong with its input power source, it is possible to carry out UPS stop processing at appropriate timing such as such a time point that all loads which are connected to the UPS completed preparation to power-off. That is, in the UPS 4 in which there occurs something wrong with an input power source, it is possible to suppress unnecessary discharge of a built-in battery (battery 216 etc. of FIG. 9 which will be described later), and as a result, it becomes possible to avoid deterioration (shortening of life) etc. of the battery.

In addition, in the above-described example, the UPS control part 83 decided respective stop timings of the output part 12-1 through the output part 12-3 of the UPS 4, and the execution timing of the UPS stop processing, at such a time point that it was monitored by the UPS monitoring part 82 that there occurred something wrong with an input power source of the UPS 4, but timing of these determinations is not limited to the above-described timing.

That is, as described above, in this embodiment, each of respective stop timings of the output part 12-1 through the output part 12-3 of the UPS 4, and the execution timing of the UPS stop processing is determined from each preparation time of each load (in this embodiment, as shown in FIG. 1, the information processing apparatus 2-1 through the information processing apparatus 2-3, and the device 3-1, and the device 3-2) of the UPS 4. In this connection, for example, the setup part 81 may determine respective stop timings of the output part 12-1 through the output part 12-3 of the UPS 4, and the execution timing of the UPS stop processing. In this case, the UPS control part 83 stores the determined respective stop timings of the output part 12-1 through the output part 12-3 of the UPS 4, and the execution timing of the UPS stop processing into the setup information storage part 85, and thereby, it becomes possible for the setup part 81 to further include (display on the display 41) these timing display 131 through display 133, on the output outlet information image, as shown in FIG. 8.

Or, the setup part 81 may determine respective stop timings of the output part 12-1 through the output part 12-3 of the UPS 4, and the execution timing of the UPS stop processing.

Next, focusing on the shutdown control part 84 of FIG. 4, the shutdown control part 84, when it is monitored by the UPS monitoring part 82 that there occurs something wrong with an input power source of the UPS 4, waits for standby time (time which was inputted into the box 92-1 of FIG. 5) having passed from that time point, as described above, and, in case that something wrong is continuously occurring in the input power source of the UPS 4 even if the standby time has passed, judges to carry out shutdown processing.

That is, in case that it was monitored by the UPS monitoring part 82 that an input power source of the UPS 4 is normal (failure was recovered) before standby time has passed, execution of the shutdown processing is unnecessary, and therefore, the shutdown control part 84 judges not to carry out the shutdown processing, and notifies such a thing to the UPS control part 83. The UPS control part 83, when it receives this notification, stops execution of the processing (i.e., prohibits the above-described stop instruction from being transmitted to the UPS 4).

In contrast to this, in case that it is still monitored by the UPS monitoring part 82 that an input power source of the UPS 4 is abnormal (in case that the UPS 4 continues to transmit “INPUT POWER SOURCE ABNORMALITY”), the shutdown control part 84 judges to carry out shutdown processing, and notifies such a thing to the UPS control part 83 at that time point, and carries out control for transmitting a shutdown instruction to each of the information processing apparatus (slave) 2-2 and the information processing apparatus (slave) 2-3 from the communication part 59 through the network 1.

At this time, in the shutdown instruction which is transmitted to the information processing apparatus (slave) 2-2, included is delay time (time which was inputted into the box 93-2 of FIG. 6) of the information processing apparatus (slave) 2-2. In the same manner, at this time, in the shutdown instruction which is transmitted to the information processing apparatus (slave) 2-3, included is delay time of the information processing apparatus (slave) 2-3 (time which was inputted into a not-shown box which corresponds to the box 93-2 of FIG. 6).

Therefore, each of the information processing apparatus (slave) 2-2 and the information processing apparatus (slave) 2-3, when it receives the shutdown instruction, starts the shutdown processing of itself, at such a time point that the delay time, which is included in the corresponding shutdown instruction, has passed from that time point.

Speaking in detail, as described above, since each of the information processing apparatus (slave) 2-2 and the information processing apparatus (slave) 2-3 has basically the same configuration (configuration of FIG. 3) as the information processing apparatus (master) 2-1, in this embodiment, it is to have basically the same functions (functions shown in FIG. 4) as the information processing apparatus (master) 2-1. In this regard, however, each of the information processing apparatus (slave) 2-2 and the information processing apparatus (slave) 2-3 carries out only a function of the shutdown control part 84 among functions shown in FIG. 4 (furthermore, among the functions, a function for carrying out the shutdown processing of itself).

That is, each shutdown control part 84 of the information processing apparatus (slave) 2-2 and the information processing apparatus (slave) 2-3 stops processing which was carried out so far by the information processing apparatus (slave) 2-2 or the information processing apparatus (slave) 2-3 itself, as the shutdown processing, and in accordance with predetermined procedures, carries out processing for transferring a state of the information processing apparatus (slave) 2-2 or the information processing apparatus (slave) 2-3 itself from an operating state to such a state that it is enabled even if supply of electric power from the UPS 4 is shut off.

Concretely speaking, for example, since each of the information processing apparatus (slave) 2-2 and the information processing apparatus (slave) 2-3 is configured as a computer as shown in FIG. 3, there are many cases that it executes application software which is operated on a predetermined OS. In this case, each shutdown control part 84 of the information processing apparatus (slave) 2-2 and the information processing apparatus (slave) 2-3 carries out processing for finishing that OS, after that application is finished, and also, necessary data is stored arbitrarily.

also, the shutdown control part 84 starts shutdown processing of the information processing apparatus (master) 2-1 itself, at such a time point that delay time (time which was inputted into the box 93-1 of FIG. 5) of the information processing apparatus (master) 2-1 has passed from such a time point that it judged to carryout shutdown processing. That is, the shutdown control part 84 of the information processing apparatus (master) 2-1 also carries out shutdown processing of itself, in the same manner as the above-described shutdown processing of the information processing apparatus (slave) 2-2 and the information processing apparatus (slave) 2-3.

In this manner, even in case that there occurred something wrong with an input power source of the UPS 4, the shutdown control part 84, before electric power from the UPS 4 is shut off, can surely complete each shutdown processing of all information processing apparatus 2 (in this embodiment, the information processing apparatus 2-1 through the information processing apparatus 2-3) which were connected to the UPS 4, and therefore, it becomes possible to surely protect information which is processed by each of the information processing apparatus 2-1 through the information processing apparatus 2-3, and the information processing apparatus 2-1 through the information processing apparatus 2-3 themselves.

As above, described was a configuration example of the information processing apparatus 2 which is connected to the UPS 4, as a load of the UPS 4, in the information processing system of FIG. 1.

Next, with reference to FIG. 9 and FIG. 10, a configuration example of the UPS 4, in the information processing system of FIG. 1, will be described. That is, FIG. 9 represents a configuration example of an inside of the Ups 4, and FIG. 10 represents a configuration example of an outer appearance of a rear surface of the UPS 4.

As shown in FIG. 9, in the UPS 4, disposed are an electric power supply part 201, a control part 202, a monitoring part 203, and a communication part 204, and the above-described output part 12-1 through the output part 12-3, and a switch 205-1 through a switch 205-3 for switching states of those outputs.

In the electric power supply part 201, the commercial alternating current power source 5 is connected to its input, and each of the output part 12-1 through the output part 12-3 is connected to its output through each of the switch 205-1 through the switch 205-3.

That is, in case that a state of the commercial alternating current power source 5, which is an input power source, is a normal state, and when respective states of the switch 205-1 through the switch 205-3 are ON states, the electric power supply part 201 supplies electric power from the commercial alternating current power source 5 to the information processing apparatus (master) 2-1 and the information processing apparatus (slave) 2-2 through the output part 12-1, and to the information processing apparatus (slave) 2-3 and the device 3-1 through the output part 12-2, and to the device 3-2 through the output part 12-3, respectively.

In contrast to this, in case that there occurred something wrong with the commercial alternating current power source 5 and when respective states of the switch 205-1 through the switch 205-3 are ON states, the electric power supply part 201 supplies electric power from a built-in battery 216 to the information processing apparatus (master) 2-1 and the information processing apparatus (slave) 2-2 through the output part 12-1, and to the information processing apparatus (slave) 2-3 and the device 3-1 through the output part 12-2, and to the device 3-2 through the output part 12-3, respectively.

In addition, an electric power supply system of the electric power supply part 201 (i.e., its configuration) is to be a so-called full-time commercial power supply system, for ease of explanation, in the example of FIG. 9, but it is not limited to the example of FIG. 9, and it is possible to apply various systems such as a so-called line interactive system, a so-called full-time inverter system. Also, in order to be able to apply a voltage of a wave form which is more close to a sine wave to a load (in this embodiment, the information processing apparatus 2-1 through the information processing apparatus 2-3, and the device 3-1 and the device 3-2) of the UPS 4, although it is not shown in the figure, there is also such a case that another constituent element such as a filter part is disposed.

In the electric power supply part 201 of FIG. 9, a detection device 211 is composed of, for example, a detection resistance etc., and detects a state (level etc. of a voltage) of the commercial alternating current power source 5 which is an input power source, and supplies its detection result to the monitoring part 203.

A state of the switch 212 is switched on the basis of control of the control part 202. That is, the control part 202 switches a state of the switch 212 to a ON state, for example, in case that a state of the commercial alternating current power source 5 which is an input power source is a normal state, and when a state of the UPS 4 is made to be transferred to an operating state (such a state that electric power is outputted). In contrast to this, for example, the control part 202 turns a state of the switch 212 to an OFF state, in case that a state of the UPS 4 is made to be transferred to a stop state (such a state that an output of electric power is prohibited).

A line 213 is a line for propagating electric power from the commercial alternating current power source 5. That is, as described later, in case that a state of the commercial alternating current power source S is a normal state (i.e., normal case), an input of the switch 214 is switched to the side of this line 213 by control of the control part 202, and electric power from the commercial alternating current power source 5 is outputted from the electric power supply part 201 through this line 213, switch 214.

In addition, hereinafter, the line 213 is referred to ordinary line 213, in order to distinguish it from a line 219 which will be described later.

Furthermore, electric power from this commercial alternating current power source 5, in case that every states of the switch 205-1 through the switch 205-3 are ON states, is supplied to each load (the information processing apparatus 2-1 through the information processing apparatus 2-3, and the device 3-1 and the device 3-2) through any one of these switch 205-1 through switch 205-3, and any one of the output part 12-1 through the output part 12-3.

A converter 215 converts an alternating-current voltage which was applied from the commercial alternating current power source 5 into a direct-current voltage of a predetermined level, and applies it to the battery 216. That is, focusing on the battery 216, the converter 215 is a charger of the battery 216, and supplies a charging current to the battery 216.

The battery 216 is a standby power supply (backup power supply) which supplies electric power to each load (the information processing apparatus 2-1 through the information processing apparatus 2-3, and the device 3-1 and the device 3-2), in case that there occurred something wrong with the commercial alternating current power source 5. That is, the control part 202, in case that there occurred something wrong with the commercial alternating current power source 5, turns a state of the switch 217 to an ON state, and also, turns an input of the switch 214 to the line 219 side (battery 216 side). Then, the battery 216 is discharged, and a direct-current voltage of a predetermined level is applied to an inverter 218.

A state of the switch 217 is switched on the basis of control of the control part 202. That is, the control part 202 switches a state of the switch 217 to an ON state, in case that a state of the UPS 4 is an operating state and also, there occurred something wrong with the commercial alternating current power source 5, and in other cases than that, it turns a state of the switch 217 to an OFF state.

The inverter 218 converts a direct-current voltage which was applied by the battery 216 into an alternating-current voltage of the same frequency (50 Hz in areas north of KANTO, 60 Hz in areas west of KANSAI) as, and almost the same level as the commercial alternating current power source 5, and outputs it to outside of the electric power supply part 201, through the line 219, and the switch 214.

A line 219 is a line for propagating electric power from the battery 216. In addition, hereinafter, the line 219 is referred to as backup line 219, in order to distinguish it from the above-described ordinary line 213.

An input of the switch 214 can be switched, on the basis of control of the control part 202, as described above. That is, the control part 202 switches an input of the switch 214 to the backup line 219 side, in case that a state of the UPS 4 is an operating state, and also, there occurred something wrong with the commercial alternating current power source 5, and turns an input of the switch 214 to the ordinary line 213 side, in other cases than it.

The control part 202 controls states of the switch 212 and the switch 217, and controls a state of an input of the switch 214, as described above, on the basis of information (e.g., the above-described stop instruction) which was transmitted from the information processing apparatus (master) 2-1 and received by the communication part 204, or, a result of monitoring of the monitoring part 203, and in addition, also controls respective states of switch 205-1 through switch 205-3 which will be described later.

Concretely speaking, for example, the control part 202 turns the switch 212 to an ON state and also, turns an input of the switch to the ordinary line 214 side, in case that a state of the commercial alternating current power source 5 is a normal state, and a state of the UPS 4 is transferred to an operating state. Also, the control part 202 turns respective states of the switch 205-1 through the switch 205-3 to ON states. By this, as described above, electric power of the commercial alternating current power source 5 is supplied to each load (the information processing apparatus 2-1 through the information processing apparatus 2-3, and the device 3-1, and the device 3-2) through the electric power supply part 201, any one of the switch 205-1 through the switch 205-3, and any one of the output part 12-1 through the output part 12-3. In addition, at this time, the control part 203 may also turns a state of the switch 217 to an OFF state.

Also, for example, in case that it was monitored by the monitoring part 203 that there occurred something wrong with the commercial alternating current power source 5, that is, in case that the above-described “INPUT POWER SOURCE ABNORMALITY”, which was generated by the monitoring part 203, is supplied to the communication part 204, and also supplied to the control part 202, the control part 202 turns a state of the switch 218 to an ON state, and also, turns an input of the switch 214 to the backup line 219 side. By this, as described above, electric power (backup electric power) from the battery 216 is supplied to each load (the information processing apparatus 2-1 through the information processing apparatus 2-3, and the device 3-1 and the device 3-2) through anyone of these switch 205-1 through switch 205-3, and any one of the output part 12-1 through the output part 12-3. In addition, at this time, the control part 202 may also turns a state of the switch 212 to an OFF state.

In case that, under this state, furthermore, the communication part 204 receives a stop instruction which was transmitted from the information processing apparatus (master) 2-1, and supplies it to the control part 202, the control part 202 turns each state of the switch 205-1 through the switch 205-3, which correspond to each of the output part 12-1 through the output part 12-3, individually, on the basis of “respective stop timings of the output part 12-1 through the output part 12-3” which are included in that stop instruction.

And, the control part 202 carries out UPS stop processing on the basis of “execution timing of UPS stop processing” which is included in that stop instruction. That is, the control part 202 turns both states of the switch 212 and the switch 217 to OFF states. By this, power supply from the electric power supply part 201 is stopped (the UPS 4 prohibits an output of electric power).

The monitoring part 203 monitors a state of the UPS 4 itself of the electric power supply part 201 etc., and also monitors a state of the commercial alternating current power source (input power source) 5 on the basis of a detection result of the detection device 211, and supplies a result of the monitoring to each of the control part 202 and the communication part 204. For example, the monitoring part 203, in case that it monitored that there occurs something wrong with the UPS 4 itself or the commercial alternating current power source 5, generates information which shows a content of that abnormality (e.g., incase of abnormality of the commercial alternating current power source 5, the above-described “INPUT POWER SOURCE ABNORMALITY”), and supplies it to each of the control part 202 and the communication part 204.

The communication part 204 carries out communication through the information processing apparatus (master) 2-1 and the communication line 21. That is, the communication part 204 transmits a monitoring result which was supplied from the monitoring part 204 to the information processing apparatus (master) 2-1 through the communication line 21. Also, the communication part 204 receivers information (e.g., the above-described stop instruction) which was transmitted from the information processing apparatus (master) 2-1 through the communication line 21, and supplies it to the control part 202. In addition, in a current case, a communication system of communication which is carried by the communication part 204 at this time is to be a serial communication system, as described above.

An input of each of the switch 205-1 thorough the switch 205-3 is switched on the basis of control of the control part 202, as described above.

Each of the output part 12-1 through the output part 12-3 is composed of one or more output outlets 231 of predetermined number (in the example of FIG. 10, 2 pieces for each), as shown in FIG. 10.

In addition, the number of the output outlet 231 for each of the output part 12-1 through the output part 12-3 is not limited to the example of FIG. 10, and may be an arbitrary number. That is, there is no necessity that the number of the output outlet 231 for each of the output part 12-1 through the output part 12-3 is particularly the same number.

In a rear surface of the UPS 4 of FIG. 10, on the left side of these output outlets 231 (the output part 12-1 through the output part 12-3), in sequence from right (in sequence from a place which is close to the output outlet 231), a plug 232 to an input power source (commercial alternating current power source 5 of FIG. 9), a fan 233 (not shown in FIG. 9), and a communication port 234 (at least a part of the communication part 204 of FIG. 9) for carrying out serial communication with the information processing apparatus (master) 2-1 are disposed respectively.

In addition, in this embodiment, since only one unit of the information processing apparatus (master) 2-1 carries out communication with the UPS 4, it is enough for the number of the communication port 234 to be basically one piece as shown in FIG. 10, but as a matter of course, it may be a plurality of pieces. Also, in this embodiment, since a communication system of the UPS 4 and the information processing apparatus (master) 2-1 is set to be serial communication, in the example of FIG. 10, a port in conformity with a serial communication system is applied to the communication port 234, but in case that a communication system of the UPS 4 and the information processing apparatus (master) 2-1 is of a different communication system, a port in compliance with that communication system is to be applied to the communication port 234.

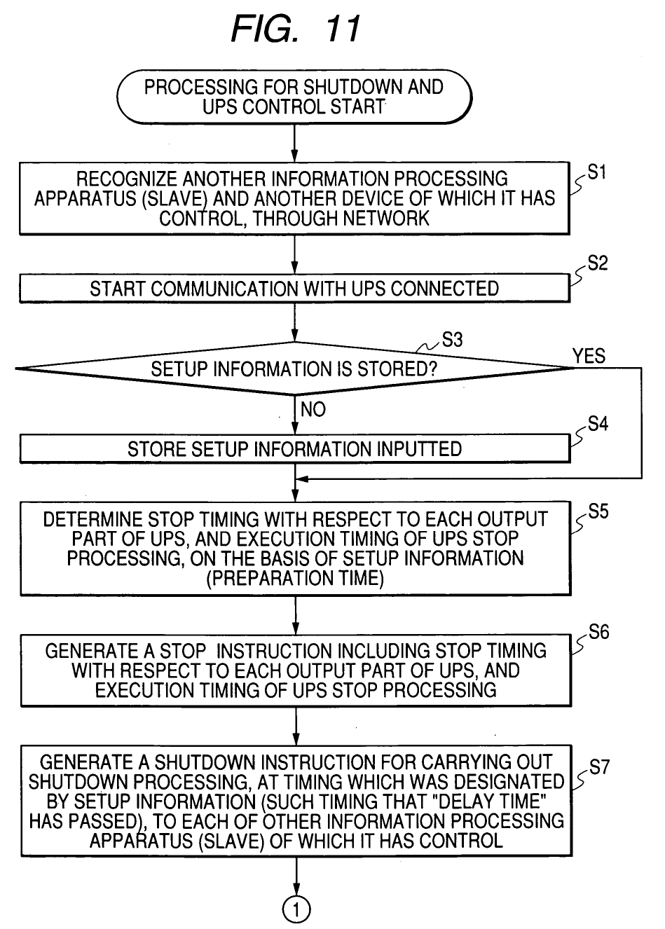

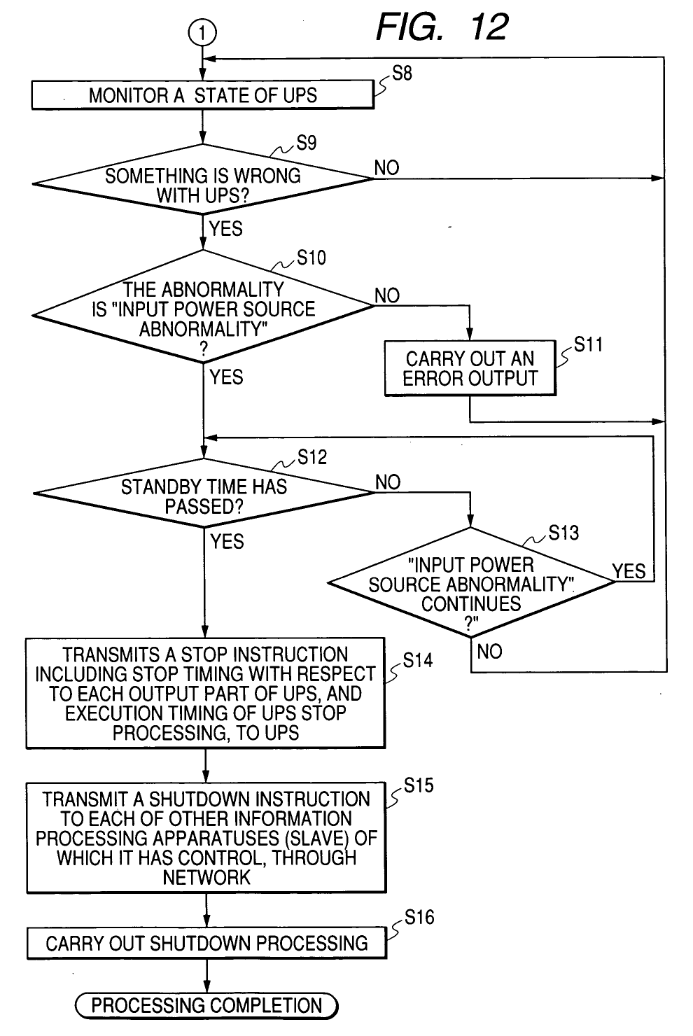

FIG. 11 and FIG. 12 are flow charts for explaining an example of such processing that the information processing apparatus (master) 2-1 of FIG. 1 (FIG. 3) monitors a state of the UPS 4, and control shutdown processing in accordance with a result of that monitoring, and also, controls respective output states of the output part 12-1 through the output part 12-3 of the UPS 4, and also, controls UPS stop processing (i.e., it is processing which corresponds to the functional block diagram of FIG. 4, and hereinafter, referred to as processing for shutdown and UPS control).

The processing for shutdown and UPS control in the information processing apparatus (master) 2-1 is started when the following first condition through fourth condition were satisfied.

That is, the first condition is that a state of the UPS 4 is transferred to an operating state.

The second condition is that states of respective power switches (not shown) of the information processing apparatus (master) 2-1, another information processing apparatus (slave) 2-2, and another information processing apparatus (slave) 2-3, and the device 3-1, and the device 3-2 are turned to ON states.

The third condition is that respective Oss of the information processing apparatus (master) 2-1, the information processing apparatus (slave) 2-2, and the information processing apparatus (slave) 2-3 are activated, and also, application software which corresponds to the setup part 81, the UPS monitoring part 82, the UPS control part 83, and the shutdown control part 84 of FIG. 4 for each of the information processing apparatus (master) 2-1, the information processing apparatus (slave) 2-2, and the information processing apparatus (slave) 2-3 is activated, i.e., in the information processing apparatus (master) 2-1, respective states of the setup part 81, the UPS monitoring part 82, the UPS control part 83, and the shutdown control part 84 are transferred to such a state that it is possible to carry out a corresponding function, and in the information processing apparatus (slave) 2-2, and the information processing apparatus (slave) 2-3, a state of the shutdown control part 84 is transferred to such a state that it is possible to carry out its function.

When the processing for shutdown and UPS control in the information processing apparatus (master) 2-1 is started, firstly, in a step S1, the information processing apparatus (master) 2-1 recognizes another information processing apparatus (slave) 2-2, and another information processing apparatus (slave) 2-3, and another device 3-1 and another device 3-2 of which it has control, through the network 1 (FIG. 1).

In a step S2, the UPS communication part 60 starts communication with the UPS 4 which was connected to the information processing apparatus (master) 2-1.

In a step S3, the setup part 81 judges whether setup information is stored in the setup information storage part 85 or not.

In case that setup information is not stored in the setup information storage part 85 (in case that, in the step S3, it was judged that setup information is not stored in the setup information storage part 85), the setup part 81, as described above, has images as shown in FIG. 5 through FIG. 7 displayed on the output part 57 (display 41), and in a step S4m stores setup information which was inputted from the input part 56 (setup information which was inputted by a user operating the input part 56 over taking a look at these images) in the setup information storage part 85, to move processing to a step S5.

In contrast to this, in case that setup information has been already stored in the setup information storage part 85 (incase that, in the step S3, it was judged that setup information is stored in the setup information storage part 85), processing of the step S4 is not carried out, and processing is moved to the step S5.

In the step S5, the UPS control part 83, as described above, determines stop timing with respect to each output part (in this embodiment, each of the output part 12-1 through the output part 12-3) of the UPS, and execution timing of UPS stop processing of the UPS 4, on the basis of the setup information which is stored in the setup information storage part 85 (to be precise, preparation time of each load of the UPS, which was set up by the setup part 81 on the basis of them).

In a step S6, the UPS control part 83 generates an stop instruction including stop timing with respect to each output part of the UPS 4, and execution timing of UPS stop processing of the UPS 4, which were determined in the processing of the step S5.

Also, in a step S7, the shutdown control part 84 generates a shutdown instruction for carrying out the shutdown processing to each of another information processing apparatus (slave) 2-2 and another information processing apparatus (slave) 2-3 of which it has control, at timing which was designated by setup information (the above-described such timing that “delay time” has passed).

In addition, execution timing of processing of the step S3 through the step S7 is not limited in particular, as described above, and for example, in the above-described example (example when FIG. 4 was described), it is set to be timing after a step S10 of FIG. 12, which will be described later, was carried out. Or, it is possible not to treat processing of the step S3 through the step S7 as internal processing of the processing for shutdown and Ups control, but it is possible to treat it as another processing (processing for setup) which is independent from the processing for shutdown and UPS control.

Focusing on the step S8 of FIG. 12, in the step S8, the UPS monitoring part 82 monitors a state of the UPS 4. Speaking in detail, as described above, since the UPS 4 transmits information which shows a state of itself or an input power source (commercial alternating current power source 5), the UPS monitoring part 82 obtains that information through the UPS communication part 60, and monitors a state of the UPS 4 on the basis of that information obtained.

In a step S9, the UPS monitoring part 82 judges whether there occurred something wrong with the UPS 4, on the basis of a monitoring result of the processing of the step S8.

The UPS monitoring part 82, in case that it monitored that a state of the UPS 4 is a normal state (i.e., in case that it judged that there occurred nothing wrong in the UPS 4 by the processing of the step S9), processing is returned to the step S8, and processing from then on is repeated. That is, the Ups monitoring part 82 always monitors a state of the UPS 4.

In contrast to this, in the step S9, in case that it was judged that there occurred something wrong with the UPS 4, the UPS monitoring part 82 judges whether the abnormality is “INPUT POWER SOURCE ABNORMALITY” or not, in the step S10.

For example, in case that the abnormality is abnormality of UPS itself (e.g., abnormality of the battery 216 of FIG. 9, etc.) (i.e., in case that it was judged that the abnormality is not “INPUT POWER SOURCE ABNORMALITY” in the step S10), the UPS monitoring part 82 carries out a predetermined error output, in a step S11. Concretely speaking, for example, the UPS monitoring part 82 has the display 41 (output part 57) displayed an image which shows a content of the abnormality. Furthermore, for example, in case that a speaker (not shown) is included as the output part 57, the UPS monitoring part 82 outputs a sound which shows a content of the abnormality from that speaker. After that, processing is returned to the step 8, and processing from then on is repeated.

In contrast to this, for example, in case that the abnormality was “INPUT POWER SOURCE ABNORMALITY” (i.e., in case that it was judged in the step S10 that the abnormality is “INPUT POWER SOURCE ABNORMALITY”), the shutdown control part 84 judges whether standby time (one of setup information stored in the setup information storage part 85) has passed or not, in a step S12.

In the step S12, in case that it was judged that standby time has not passed, the shutdown control part 84 judges whether “INPUT POWER SOURCE ABNORMALITY” continues or not, in a step S13.

For example, in case that a state of an input power source of the UPS 4 was recovered, the UPS stops transmission of “INPUT POWER SOURCE ABNORMALITY”, and therefore, in the suchlike case, execution of shutdown processing becomes unnecessary, and in the step S13, it is judged that “INPUT POWER SOURCE ABNORMALITY” does not continue, and processing is returned to the step S8, and processing from then on is repeated.

In contrast to this, in case that abnormality of an input power source of the UPS 4 continues, the UPS 4 continues to transmit “INPUT POWER SOURCE ABNORMALITY”, and therefore, in the suchlike case, in the step S13, it is judged that “INPUT POWER SOURCE ABNORMALITY” is continuing, and processing is returned to the step S12, and it is judged again whether standby time has passed or not.

That is, the shutdown control part 84, in case that a state of an input power source of the UPS 4 was recovered before standby time has passed, prohibits execution of shutdown processing, and processing is returned to the step S8, and in other cases than it (in case that abnormality of an input power source of the UPS 4 is continuing after standby time passed), in the step S12, it is judged that standby time has passed. At this time point, the shutdown control part 84 judges to carry out shutdown processing, and notifies such a thing to the UPS control part 83.

The UPS control part 83, when it receives this notification, carries out control for transmitting a stop instruction including stop timing with respect to each output part of the UPS 4 (in this embodiment, each of the output part 12-1 through the output part 12-3 of the UPS 4), and execution timing of UPS stop processing of the UPS 4, which were generated in processing of the step S6 (as described above, they may be generated at the present moment), from the UPS communication part 60 to the UPS 4. That is, in a step S14, the UPS communication part 60 transmits a stop instruction to the UPS 4.

Then, the UPS 4, after it receives that stop instruction, turns respective output states of the output part 12-1 through the output part 12-3 to a stop state, individually (turns respective states of the switch 205-1 through the switch 205-3 of FIG. 9 to an OFF state, individually), at respective stop timing of the output part 12-1 through the output part 12-3, which is included in that stop instruction. And, the UPS 4, after it receives that stop instruction, carries out UPS stop processing (processing for transferring an operating state in which electric power is outputting to a stop state in which an output of electric power is prohibited), at execution timing of UPS stop processing of the UPS (in the present case, the same timing as stop timing of the output part 12-1), which is included in that stop instruction.

Also, the shutdown control part 84 carries out control for transmitting a corresponding shutdown instruction from the communication part 59 through the network 1 to each of another information processing apparatus (slave) 2-2 and another information processing apparatus (slave) 2-3 of which it has control. That is, in a step S15, the communication part 59 transmits a corresponding shutdown instruction to each of another information processing apparatus (slave) 2-2 and another information processing apparatus (slave) 2-3 of which it has control, through the network 1.

Then, each of another information processing apparatus (slave) 2-2 and another information processing apparatus (slave) 2-3 starts shutdown processing after it receives the corresponding shutdown instruction and delay time, which is included in that shutdown instruction, has passed.

In addition, the shutdown processing of another information processing apparatus (slave) 2-2 is completed before a state of the output part 12-1 of the UPS 4 is turned to a stop state, and the shutdown processing of another information processing apparatus (slave) 2-3 is completed before a state of the output part 12-2 of the UPS 4 is turned to a stop state.

Furthermore, the shutdown control part 84, in a step S16, carries out shutdown processing. In addition, start timing of this step S16 is set to be such timing that delay time of the information processing apparatus (master) 2-1 has passes from such a time point that it was judged that standby time has passed in the step S12, as described above. Also, shutdown processing of the information processing apparatus (master) 2-1 is also completed before a state of the output part 12-1 of the UPS 4 is turned to a stop state.

In the meantime, in case of carrying out the above-described series of processing by use of software, a program which configures that software is installed in a computer which is built in dedicated hardware, or installed in, for example, a general purpose computer etc., which is capable of carrying out various types of functions by installing various types of programs, from a network and a computer-readable medium.

Concretely speaking, for example, a program which configures application software having each of the setup part 81, the UPS monitoring part 82, the UPS control part 83, and the shutdown control part 84, which are shown in FIG. 4, as modules is installed in a computer which is built in dedicated hardware, or installed in, for example, a general purpose computer etc., which is capable of carrying out various types of functions by installing various types of programs, from a network and a computer-readable medium.

A computer-readable medium which includes the suchlike program, for example, as shown in FIG. 3, is composed of not only a removable computer-readable medium (package media) 71 which comprises a magnetic disk (including a floppy disk), an optical disk (including a CD-ROM (Compact Disk-Read Only Memory), a DVD (Digital Versatile Disk)), a magneto-optical disk (including MD (Mini-Disk)), or a semiconductor memory etc., which is distributed for providing a program to a user, separately from an apparatus main body, and in which a program is recorded, but also a ROM 52 which is provided to a user in such a state that it has been built in an apparatus main body in advance, and in which a program is recorded, a hard disk which is included in the storage part 58, and so on.

In this regard, however, as to each of the setup part 81, the UPS monitoring part 82, the UPS control part 83, and the shutdown control part 84, which are shown in FIG. 4, its form is not limited in particular, if it carries out its function, as described above.

That is, for example, each of the setup part 81, the UPS monitoring part 82, the UPS control part 83, and the shutdown control part 84, which are shown in FIG. 4, may be composed of hardware. In that case, a manufacturer etc. manufactures hardware which corresponds to the setup part 81, the UPS monitoring part 82, the UPS control part 83, and the shutdown control part 84, which are shown in FIG. 4, respectively, and connects them as shown in FIG. 4, and thereby, it becomes possible to easily realize an information processing apparatus of a different configuration from FIG. 3.

Also, for example, even in case that each of the setup part 81, the UPS monitoring part 82, the UPS control part 83, and the shutdown control part 84, which are shown in FIG. 4, is composed of software, its configuration is not limited to the example of FIG. 4, and for example, maybe a module configuration which comprises a module in which a part or all of the setup part 81, the UPS monitoring part 82, the UPS control part 83, and the shutdown control part 84 were combined, or a module configuration which comprises modules in which a function of any one of the setup part 81, the UPS monitoring part 82, the UPS control part 83, and the shutdown control part 84 was divided. Or, it may be simply a program which has one algorithm.

In addition, in this specification, a step for describing a program to be recorded in a computer-readable medium includes not only processing which is carried out in chronological order along its order as a matter of course but also processing which is carried out in parallel or individually even if it is not necessarily processed in chronological order.

Also, in this specification, a system represents an entire apparatus which is composed of a plurality of devices and processing parts.

1. An information processing apparatus comprising:
a first communication unit for bilaterally transmitting and receiving an information to and from a power supply device having a plurality of output parts for outputting an electric power;
a monitoring unit for monitoring a state of the power supply device, on the basis of the information which was transmitted from the power supply device and received by the first communication unit; and
a control unit for carrying out a control for generating a control information for individually controlling respective states of the plurality of the output parts of the power supply device, on the basis of a result of monitoring of the monitoring unit, and for transmitting the control information from the first communication unit to the power supply device.

2. The information processing apparatus as set forth in claim 1, wherein the control unit, incase that it was monitored by the monitoring unit that there occurred something wrong with an input power source of the power supply device, carries out a control for determining individually respective stop timings for taking down respective outputs of the plurality of the output part of the power supply device, in accordance with characteristics of respective loads of the corresponding output parts, for generating the control information including at least each of the stop timings of the plurality of the output parts, and for transmitting the control information from the first communication unit to the power supply device.

3. The information processing apparatus as set forth in claim 2, further comprising:
a setup unit for setting up, as respective features of the one or more load, which are connected to the plurality of output parts of the power supply device, respective preparation times which are necessary for a preparation to shutoff of an electric power from the corresponding output part, which is carried out by each of those loads,
wherein the control unit, in case of individually determining the stop timing of each of the plurality of the output parts of the power supply device, searches the preparation time of maximum length, out of the preparation time of each of one or more the load of the output part to draw attention, among the preparation times which were set up by the setup unit, and determines the stop timing of the output part to draw attention on the basis of the searched preparation time of maximum length.

4. The information processing apparatus as set forth in claim 3, wherein the control unit further carries out a control for determining a stop timing of the power supply device itself for transferring a state of the power supply device from an operating state for having electric power outputted from at least one out of the plurality of the output parts to a stop state for having all output of the plurality of the output part stopped, on the basis of the preparation time of maximum length out of all of the preparation times which were set up by the setup unit, for generating the control information further including the stop timing of the power supply device itself, in addition to the stop timing of each of the plurality of the output parts of the power supply device, and for transmitting the control information from the first communication unit to the power supply device.

5. The information processing apparatus as set forth in claim 3, wherein the information processing apparatus itself is connected to predetermined one out of the plurality of the output parts, as the load of the power supply device, and wherein the information processing apparatus further comprises:
a state transfer unit for stopping a processing which has been carried out by the information processing apparatus itself up to now, in case that it was monitored by the monitoring unit that there occurred something wrong with an input power source of the power supply device, and for transferring a state of the information processing apparatus itself from an operating state to such a state that it is enabled even if an electric power from the output part of the power supply device, to which the information processing apparatus itself was connected was shut off, in accordance with a predetermined procedure,
wherein the setup unit sets up such time that a first delay time from a time point when the state transfer unit judged to carry out the state transfer processing until when it is actually started is added to such processing time that the state transfer unit carries out the state transfer processing, as the preparation time of the information processing apparatus itself.

6. The information processing apparatus as set forth in claim 5, further comprising:
a second communication unit for bilaterally transmitting and receiving an information to and from another information processing apparatus which was connected to predetermined one out of the plurality of the output parts of the power supply device,
wherein the setup unit sets up such time that a second delay time from a time point when the another information processing apparatus judged to carry out a state transfer processing until when it is actually started is added to such processing time that the another information processing apparatus carries out the state transfer processing, as the preparation time of the another information processing apparatus, and
wherein the state transfer unit, at such a time point that it judged to carry out the state transfer processing of the information processing apparatus itself, further carries out a control for generating an instruction for having the another information processing apparatus started the state transfer processing after the second delay time, which was set up by the setup unit, has passed, and for transmitting the instruction from the second communication unit transmitted to the another information processing apparatus.

7. An information processing method of an information processing apparatus having a communication unit for bilaterally transmitting and receiving an information to and from a power supply device which has a plurality of output parts for outputting an electric power, the method comprising:
monitoring a state of the power supply device, on the basis of the information which was transmitted from the power supply device and received by the communication unit;
carrying out a control for generating a control information for individually controlling respective states of the plurality of the output parts of the power supply device, on the basis of a result of monitoring of the monitoring step; and
transmitting the control information from the communication unit to the power supply device.

8. The information processing method as set forth in claim 7, wherein in case that it was monitored that there occurred something wrong with an input power source of the power supply device, the control carrying-out step carries out a control for determining individually respective stop timings for taking down respective outputs of the plurality of the output part of the power supply device, in accordance with characteristics of respective loads of the corresponding output parts, and for generating the control information including at least each of the stop timings of the plurality of the output parts.

9. A computer-readable medium storing instructions for operating an information processing apparatus which has a communication unit for bilaterally transmitting and receiving an information to and from a power supply device which has a plurality of output parts for outputting an electric power, the instructions comprising:
monitoring a state of the power supply device, on the basis of the information which was transmitted from the power supply device and received by the communication unit;
carrying out a control for generating a control information for individually controlling respective states of the plurality of the output parts of the power supply device, on the basis of a result of monitoring of the monitoring step; and
transmitting the control information from the communication unit to the power supply device.
